(19) United States
(12) Patent Application Publication
(10) Pub. No.: US 2026/0050194 A1
(43) Pub. Date: Feb. 19, 2026

(54) APPARATUS AND METHODS FOR DIFFRACTION-FREE PATTERNING OF OPTICAL SIGNALS AND IMAGES IN DISPLAY SYSTEMS

(71) Applicant: BRELYON, Inc., San Mateo, CA (US)

(72) Inventors: Barmak Heshmat Dehkordi, San Mateo, CA (US); Christopher Barsi, Lee, NH (US); Yushin Kim, San Mateo, CA (US)

(73) Assignee: BRELYON, Inc., San Mateo, CA (US)

(21) Appl. No.: 18/808,340

(22) Filed: Aug. 19, 2024

(51) Int. Cl. G02F 1/139; G02F 1/00; G02F 1/01; G02F 1/1335; G02F 1/13357

(52) U.S. Cl. CPC G02F 1/1392; G02F 1/0147; G02F 1/133514; G02F 1/133531; G02F 1/133553; G02F 1/133605; G02F 1/133614; G02F 1/009; G02F 2202/36

(57) ABSTRACT

Systems and methods of optical transverse patterning of image-forming light rays include a programming element to generate a pattern that a modulating element imprints onto the image-forming light rays. In some embodiments, the programming element and the modulating element are the same component within the system. In some embodiments, the pattern is free of farfield diffractive artifacts.

### FIELD OF THE INVENTION

The present invention relates generally to optical systems, such as display systems. The embodiments of the invention use a secondary source to program transversely non-uniform patterns onto the intensity, polarization, spectrum, or angular profile of image-forming light, such that the light is free from diffractive artifacts or has reduced diffractive artifacts.

### BACKGROUND

Optical display systems, such as lightfield and autostereoscopic three-dimensional (3D) displays, are used for immersive content and are enjoying increasing use with advancements in electronics and microfabrication. 3D display technologies, such as virtual reality (VR) and augmented reality (AR) headsets, often present to a viewer an image that is perceived at a depth far behind the display device itself. Refractive elements can produce such an image, but they cause increased bulk and optical aberrations. Further, such displays often suffer from the vergence-accommodation mismatch, and they may cause eye strain, nausea, or other fatigue symptoms. Some methods to alleviate these issues introduce optical components that are pixelated and introduce various farfield diffractive artifacts, which are typically unwanted.

Some virtual display systems are designed and implemented with various specifications to alleviate these problems. For example, in U.S. Pat. Nos. 11,067,825 B2 and 11,768,825 B1, Dehkordi described a virtual display system providing monocular and binocular depth cues to achieve realistic depth perception effects. In U.S. Pat. No. 11,592,684 B2, Dehkordi disclosed an optical component called a field evolving cavity to make the light source appear farther from the viewer compared to the distance to the physical display system. In U.S. Pat. No. 11,196,976 B2, Dehkordi further disclosed a virtual display system directed to tessellating a light field to extend beyond the pupil size of a display system. In U.S. Pat. No. 11,662,591 B1, Dehkordi et al disclosed an apparatus for modifying the monocular depth of virtual images dynamically and for producing a multifocal virtual image. Last, in U.S. Pat. No. 11,774,762 B1, Dehkordi et al disclosed a method for increasing the efficiency of virtual image systems with monocular depth.

### SUMMARY

Optical systems like display systems emit light forming an image for a viewer's consumption. The image may be a virtual image with a perceived depth that is different than a distance between the viewer and a component of the display system itself. Presently, there has been increasing traction toward more immersive display systems, larger-sized display systems that do not require headgear, display systems that provide dynamic content, or multiple images that appear at different perceived depths. Some immersive displays are virtual display systems that provide various depth cues, but current art is limited in several respects. For example, optical components may be introduced to improve image quality or introduce useful effects, but they cause unwanted effects such as pixelation, rainbow patterns, Moiré, and other diffractive effects.

An objective of the present invention is to introduce a structure, component, or subsystem that improves the visual results of display systems without introducing unwanted artifacts that are caused by pixelated screens or electrically addressable arrays or to reduce such artifacts.

In an embodiment an optical system, comprises a light source emitting light forming an image, a secondary source to generate a pattern, a programming element to be modified by the pattern, and a modulation element coupled to the programming element to (i) receive the light and (ii) modify a transversely varying optical property of the light in accordance with the pattern, the transversely varying optical property free from farfield diffractive artifacts.

In some embodiments of the optical system, the image spans a lateral distance of at least 10 cm.

In some embodiments, the optical system further comprises an FEC having at least two specular reflectors disposed along a path of the light, wherein the image is a virtual image with at least one monocular depth and is viewable in a headbox having a lateral size of at least 10 cm.

In some embodiments of the optical system, the light source is a plurality of light sources.

In some embodiments of the optical system, the modulation element is disposed on a surface of a specular reflector among the plurality of specular reflectors.

In some embodiments of the optical system, the secondary source is an optical source, the programming element is a photoresponsive element, the modulation element is an electro-optic element, and further comprises a filter and a polarizer.

In some embodiments of the optical system, the photoresponsive material comprises a transparent photovoltaic material or a transparent conductor.

In some embodiments of the optical system, the secondary source comprises an ultraviolet (UV) optical source and an addressable matrix, the modulation element comprises a luminescent element, and further comprising a color filter to remove stray light.

In some embodiments of the optical system, the light source emits white light.

In some embodiments, the optical system further comprises a cavity, the modulation element disposed within the cavity.

In some embodiments of the optical system, the modulation element is pixelated.

In some embodiments of the optical system, wherein the modulation element comprises a photorefractive material, and the transversely varying optical property is an optical phase.

In some embodiments of the optical system, the image is a multifocal virtual image comprising a first focal plane and a second focal plane, the pattern based on a first display content of the first focal plane and the transversely varying optical property impacting a second display content on the second focal plane.

In some embodiments of the optical system, the programming element is pixelated.

In some embodiments, an optical system comprises a light source emitting light forming an image, a secondary source to generate a pattern, and a meshless optic coupled to the secondary source and having a modulation material to receive the pattern, and a programming material, wherein the meshless optic (i) receives the light, and (ii) modifies a transversely varying optical property of the light in accordance with the pattern, the transversely varying optical property free from farfield diffractive artifacts.

In some embodiments of the optical system, the meshless optic comprises a phase change material, and the secondary source is thermally coupled to the phase change material.

In some embodiments of the optical system, the meshless optic comprises a multilayer stack.

In some embodiments of the optical system, a layer of the multilayer stack is a polymer, the secondary source changing a local thickness of the polymer.

In some embodiments of the optical system, the secondary source is the light from the light source, and the meshless optic is a nonlinear material.

In some embodiments of the optical system, the modulation material is an electro-optic substrate, and the programming material is dispersed or doped in the electro-optic substrate.

In some embodiments of the optical system, the programming material is a dispersal of resonant nanoparticles.

In some embodiments of the optical system, the meshless optic comprises a dispersal of luminescent particles.

In some embodiments of the optical system, the meshless optic further comprises a dispersal of resonant nanoparticles coupled to the luminescent particles.

In some embodiments, an optical system comprises a light source emitting light forming an image, a secondary source to generate a pattern, a programming element to be modified by the pattern, and a modulation element coupled to the programming element to (i) receive the light and (ii) modify a transversely varying optical property of the light in accordance with the pattern, the transversely varying optical property free from farfield diffractive artifacts, wherein the secondary source is a source array disposed on the programming element.

In some embodiments of the optical system, the source array is an array of electrodes.

In some embodiments of the optical system, the image is a multifocal virtual image comprising a first focal plane and a second focal plane, the pattern based on a first display content of the first focal plane and the transversely varying optical property impacting a second display content on the second focal plane.

In some embodiments of the optical system, the programming element is a photoresponsive element.

In some embodiments of the optical system, the modulation element is a nonlinear material.

In some embodiments of the optical system, the source array is an array of acoustic or mechanical transducers.

In some embodiments of the optical system, the modulation element is an elastic membrane having a dispersal of luminescent particles.

In some embodiments of the optical system, the source array is an array of thermo-electric transducers, and further comprising a conducting slab disposed between the programming element and the modulation element.

### BRIEF DESCRIPTION OF THE DRAWINGS

FIG. 1 illustrates common features, components, or elements of the disclosed embodiments.

FIGS. 2A through 2C depict a set of subsystems and optical architectures using the components of FIG. 1.

FIGS. 3A through 3D illustrate the main embodiments of the present invention, which uses coupling mechanisms for patterning image-forming light signals without introducing diffractive artifacts.

FIGS. 4A through 4C depict a set of block diagrams to explain the functionality of the embodiments disclosed herein.

FIGS. 5A through 5E illustrate some of the light delivery systems used in the optical generation of the pattern formation.

FIGS. 6A through 6M show embodiments in which multiple elements serve to generate the patterning effect disclosed herein.

FIGS. 7A through 7H show embodiments in which the modulation and patterning occur within a single element or via a cascade of effects.

FIGS. 8A through 8I are a set of embodiments using multilayer effects or thin films to produce the patterning effects.

FIGS. 9A through 9I are a set of embodiments using edge sources or source arrays, similar to that in FIG. 3D.

FIGS. 10A and 10B are analysis plots of the edge-source-array embodiments.

FIGS. 11A through 11C show auxiliary embodiments to generate diffraction-free or diffraction-reduced patterns through high-frequency or low-frequency masking techniques.

FIGS. 12A through 12K describe further embodiments of display systems using the patterning methods of the present invention.

FIGS. 12L through 12M depict several methods of generating content from the embodiments disclosed herein.

FIGS. 13A through 13K depict how the embodiments disclosed are integrated into portable devices, including in-vehicle display systems, ARVR headsets, and hand-held devices.

### DETAILED DESCRIPTION

Modern display devices offer new channels of image quality, immersion quality, content creation and sharing, and user interaction. Immersive content and hardware, such as augmented reality (AR), virtual reality (VR), extended reality (XR), mixed reality (MR), headsets, and free-standing virtual display systems, are all modalities that offer unexplored methods and software applications to enhance human productivity and entertainment. Software and hardware mechanisms may generate visual content in new and unique ways to amplify or enrich the user experience.

For example, mechanisms incorporate such content into a variety of display systems that include, but are not limited to, three-dimensional displays, virtual and multilayer displays, or even multi-monitor setups. In some embodiments, the display images are just 2D images extended to side panels and monitors. In some other embodiments, the display provides images with monocular depth, wherein a viewer experiences accommodation depth cues to at least one image plane. In some embodiments, the display images are stereoscopic images. In some embodiments, both stereoscopic and monocular depth cues are provided.

Because an image is a spatially varying optical pattern, any display system must be able to convey or modify such patterns. With modern electronics, such components and sources are often pixelated at a scale near the wavelength of the image-forming light, such that diffractive artifacts are introduced and reduce image quality. The present invention discloses apparatus and methods for impacting images without reducing the image quality to this extent, in particular, but not limited to, free-standing virtual display systems.

### Nomenclature

In this description, references to an “embodiment,” “one embodiment,” or similar words or phrases mean that the feature, function, structure, or characteristic being described is an example of the technique or invention introduced here. Occurrences of such phrases in this specification do not necessarily all refer to the same embodiment. On the other hand, the embodiments referred to herein also are not necessarily mutually exclusive. The invention here is explained relative to preferred embodiments, but it is to be understood that modifications or variations can be made without departing from the scope of the claimed invention.

All references to “user,” “users,” “observer,” or “viewer,” pertain to either an individual or individuals who would use the apparatus, methods, and techniques introduced here. A user interacts with a system using a sense, which could be visual, auditory, tactile, or olfactory. In some embodiments, the system is a display system and the user or viewer is viewing the image content. A user may be a future or past user to allow for asynchronous applications.

The term “arbitrarily engineered” means being of any shape, size, material, feature, type or kind, orientation, location, quantity, components, and arrangement of single components or arrays of components that enables the present invention. Two elements are “optically coupled” when the first element being imparts, transfers, feeds, or directs light to the second element directly or indirectly. More generally, two elements are “coupled” when the first element being imparts, transfers, feeds, or directs energy or information to the second element directly or indirectly. The energy may be light, acoustic, thermal, electronic, mechanical, radio-frequency or other electromagnetic energy, and the like. The information includes any structure of the energy forming data.

In this disclosure, the “lightfield” at a plane refers to a vector field that describes the amount of light flowing in every or several selected directions through every point in that plane. The lightfield is the description of the angles and intensities of light rays traveling through or emitted from that plane. A “fractional lightfield” is a subsampled version of the lightfield such that full lightfield vector field is represented by a finite number of samples in different focal planes and/or angles. Some lightfield models incorporate wave-based effects like diffraction. A lightfield display is a three-dimensional display that is designed to produce 3D effects for a user using lightfield modeling. The terms “concentric light field” or “curving light field” as used herein mean a lightfield for which for any first pixel and second pixel of the display at a fixed radius from the viewer, the chief ray of the light cone emitted from the first pixel in a direction perpendicular to the surface of the display intersects with the chief ray of the light cone emitted from the second pixel in a direction perpendicular to the surface of the display. A concentric lightfield produces an image that is focusable to the eye at all points, including pixels that are far from the optical axis of the system (the center of curvature), where the image is curved rather than flat, and the image is viewable within a specific viewing space (headbox) in front of the lightfield. As used herein, the term “chief ray” refers to the central axis of a light cone that is emitted by a pixel source or a point-like source, or that is reflected by a point on an object.

“Monocular optical depth” or “monocular depth” is the perceived distance, or apparent depth, between the observer and the apparent position of an image. It equals the distance to which an eye accommodates (focuses) to see a clear image. Thus, the monocular depth is the accommodation depth corresponding to the accommodation depth cue. Each eye experiences this depth cue.

A “virtual image” is an image that triggers a depth cue of a viewer, who consequently perceives display content at variable depths, different parts of the display content at various depths relative to each other, or display content that appears at a different depth than a distance between the viewer and a component of the physical display system. For example, some depth cues are parallax effects. In some embodiments, 3D effects are triggered stereoscopically by sending a different image to each eye corresponding to a disparity. In some embodiments, depth cues are triggered using monocular depth cues, wherein each eye focuses or accommodates to the appropriate monocular depth. Virtual images may be multifocal, varifocal, lightfield images, holographic, stereoscopic, autostereoscopic, or (auto)multi-scopic. The virtual depth of a virtual image may be dynamically adjustable via a control in the display system, a user or sensor input, or a pre-programmed routine.

Monocular depths may be understood as follows. A point source of light emits light rays equally in all directions, and the tips of these light rays can be visualized as all lying on a spherical surface, called a wavefront, of expanding radius. In geometric optics in, for example, free space or isotropic media, the wavefront is identical the surface that is everywhere perpendicular to the light rays, and can be calculated by e.g., the eikonal equation, Lagrangian optics, Hamiltonian optics, and the like. When the point source is moved farther from an observer, emitted light rays travel a longer distance to reach the observer and therefore their tips lie on a spherical wavefront of larger radius and correspondingly smaller curvature, i.e., the wavefront is flatter. This flatter wavefront is focused by an eye differently than a less flat one. Thus, the point source is perceived by an eye or camera as a farther distance, or deeper depth, to the object. Monocular depth does not require both eyes, or stereopsis, to be perceived. An extended object can be considered as a collection of point sources at varying positions and as consequently emitting a wavefront corresponding to the sum of the point-source wavefronts, so the same principles apply to, e.g., an illuminated object or emissive display panel. Wavefront evolution refers to changes in wavefront curvature due to optical propagation.

A virtual image is produced by virtual display system, which produces images at two or more perceived depths, or a perceived depth that is the different from the depth of the display panel that generates the image. A virtual display system may be a free-standing system, similar to a computer monitor or television set. It may also be part of a cellphone, tablet, headset, smart watch, or any portable device. It may be for a single user or multiple users in any application. Virtual display systems may be volumetric or lightfield displays, multifocal displays, and the like. In some embodiments, the virtual display system is a holographic display, which relies on the wave nature of light to produce images based on manipulating interference the light.

“Depth modulation” refers to the change, programming, or variation of the monocular depth of a virtual image.

A virtual image is to be viewed by an observer, rather than be projected directly onto a screen. The light forming the image has traveled an optical distance corresponding to the monocular depth at which a viewer perceives the image. The geometric plane in space in which the virtual image is located is called the “focal plane.” Concentric lightfield displays may produce curved focal planes. A virtual image comprising a set of virtual images at different focal planes is called a “multifocal image” or “multilayer image.” E.g., a multilayer display system is one in which display content is shown in such a way that a viewer must accommodate his eyes to different depths to see different display content. A virtual image whose focal plane can be adjusted dynamically, e.g., by varying an optical or electrical property of the display system, is also called a multifocal image. A virtual display system that produces multifocal images may be called a “multifocal display system,” “multilayer display system,” and the like. A monocular depth at which content is located is also called a “virtual depth,” or “focal plane.” Multilayer displays comprise transparent displays in some embodiments. Content at a given virtual depth may be called a “layer,” “depth layer,” “virtual layer,” and the like.

A display system may produce a real image in the space outside the display system. (A real image forms where the light rays physically intersect, such that a film placed at that location will record a (collection of) bright spot(s), corresponding to an image.) The light rays diverge beyond that intersection point, such that a viewer sees a virtual image. That virtual image is first formed as a real image and will appear to the viewer as floating, or hovering, in front of the display panel, at the location of the real image location. This image is called a “hovering real image.”

The term “display content” is used to describe the source information or the final image information that is perceived by a viewer.

In “eyebox” is the volume of space wherein a human eye may be located to view an image. In some embodiments, the virtual display system produces an eyebox whose volume is big enough to encompass both eyes of a viewer simultaneously. In another embodiment, the virtual display system produces a left eyebox and a right eyebox, configured for simultaneous viewing by the left and the right eye, respectively. The size and number of eyeboxes depends on the specific nature and design of the display. “Headbox” is the volume of space where a viewer's eyes may be positioned for an image to be visible. In some embodiments, the headbox is larger than the average interpupillary distance for a person, such that both eyes can be located within the headbox simultaneously. The virtual images disclosed herein are simultaneously visible by both eyes of a view. In some embodiments the headbox is large enough for a plurality of viewers to see a virtual image. In some embodiments, headbox and eyebox are used interchangeably.

When the headbox is big enough to encompass both eyes of a viewer, each point of the virtual image is visible by both eyes of the viewer, i.e., light rays from any given point of the virtual image enter both eyes simultaneously. To receive the virtual image, the viewer's eyes may be located anywhere within the headbox, which spans a lateral dimension. The lateral dimension may be, for example, at least 8 cm, at least 10 cm, at least 15 cm, at least 20 cm, or at least 30 cm. The distance between the display system and the nearest viewing position in the headbox may be, for example, between at least 30 and 60 cm, greater than 20 cm, or less than 100 cm. This distance is in part limited by the viewing direction required to see the virtual image.

Display systems may incorporate any hardware, including liquid crystals or other polarization-dependent elements to impact properties of the display; any type of mirror or lens to redirect the light path, influence the size in any dimension, modify the focal depth, or correct for aberrations and distortions; any surface coatings, active elements; spectral or spatial filters to assist in image quality; optical cavities; or any type of element or coating to serve as a shield layer or antireflection layer to reduce unwanted, stray, or ambient light from reaching a viewer. In some embodiments, display systems comprise metamaterials and metasurfaces, nonlinear optical elements, photonic crystals, graded-index materials, anisotropic or bi-anisotropic elements, or electro-optic elements. In some embodiments, display systems are virtual display systems. Further, display systems can be of any modality, including infrared (IR), mid-IR, near-IR, far-IR, ultraviolet (UV), terahertz (THz), radiofrequency, or acoustic or ultrasonic (for consumption by a person's human auditory or tactile senses). The displays, or elements of the display may be curved in some embodiments.

A display system can produce images, overlay annotations on existing images, feed one set of display content back into another set for an interactive environment, or adjust to environmental surroundings. Users may have VR, AR, MR, or XR experiences; video-see through effects; monitor remote systems and receive simultaneous predictive suggestions; provide an avatar with permissions to make imprints on digital content or online resources; or use AI for generative content creation. A subsection of the display content may be input into an algorithm to impact another subsection.

A “subsection” of display content is a partitioning of the display content produced by the display system. In some embodiments, a subsection is a pixel or set of pixels. The set of pixels may be disjoint or contiguous. In some embodiments, a subsection corresponds to a feature type of the display content. For example, a subsection of an image of a person may be a head or an arm, and another subsection may be a hand or an eye. In some embodiments, a subsection may be an entire layer or part of a layer or focal plane of a display that produces multiple focal planes. In some embodiments, a subsection is a part of the spectral content of an image or a portion of the image in an arbitrary mathematical basis. Subsections may also be partitioned differently at various times. In some embodiments, a subsection is one of the segments of a segmented display.

Display content may be manipulated by a user or interactive with a user through various input devices. Input devices are types of sensors that take in a user input, usually deliberately rather than automatically. Input devices, such as cameras, keyboard and mouse input, touch screens, gesture sensors, head tracking, eye tracking, VR paddles, sound input, speech detection, allow for user feedback in multiple modalities. In some embodiments, various biological or health sensors capture information—such as heart rate, posture, seating or standing orientation, blood pressure, eye gaze or focus—and use that information in an algorithm to influence or impact the displayed content.

An “addressable matrix” or “pixel matrix” is a transmissive element divided into pixels that can be individually (e.g., electrically) controlled as being “ON,” to transmit light, or “OFF,” to prevent light from passing, such that a light source passing through can modulated to create an image. The examples of displays above include such matrix elements. Generally, a “modulation matrix” is an element that is segmented such that light traveling incident on different portions of the modulation matrix experience different optical properties of the modulation matrix, the different optical properties being controllable. Such a layer is used to imprint spatial information, such as an image, onto the light. A modulation matrix may be absorptive, reflective, transmissive, or emissive; and it may comprise electrophoretic, absorptive, fluorescent or phosphorescent, mechanical, birefringent, electrooptic materials. An addressable matrix is an example of a modulation matrix layer. In some embodiments the optical properties of each portion of a modulation matrix depend also on the incident light (e.g., for a photochromic-based modulation matrix).

As used herein, the “display aperture” is the surface where the light exits the display system toward the exit pupil of the display system. The aperture is a physical surface, whereas the exit pupil is an imaginary surface that may or may not be superimposed on the aperture. After the exit pupil, the light enters the outside world.

As used herein, the “imaging aperture” is the area or surface where the light enters an imaging system after the entrance pupil of the imaging system and propagates toward the sensor. The entrance pupil is an imaginary surface or plane where the light first enters the imaging system.

“Image aperture,” “aperture optic,” “exit aperture optics” or “exit aperture,” and the like correspond interchangeably to a set of optical elements located at the display aperture surface. In some embodiments, the set contains only one element, such as a transparent window. Exit aperture optics protect the inside of the display system from external contaminants. Exit aperture optics are also used to prevent unwanted light from entering the display system. In a display system, “stray light” is unwanted light that interacts with the display system and travels along a substantially similar path as the desired image into a viewer's eyes. E.g., stray light includes ambient light that enters the system through an undesired entrance and finally exits through the display aperture to be visible by an observer, thus degrading the viewing experience. With exit aperture optics, such stray light prevents or mitigates this degradation by removing stray light or its effects. In some embodiments, exit aperture optics includes a wave plate and a polarizer. In some embodiments, it includes an anti-reflection coating. In the context of stray light mitigation, an exit aperture may also be called an “ambient light suppressor.”

In display systems that use ambient or environmental light as the light source, the ambient light enters the display system through a set of optics called an “entrance aperture” or, equivalently, “entrance aperture optics.” In some embodiments, this set contains only one element, which may be a single transparent element to transmit the ambient light into the display system. Entrance aperture optics is located at the surface where the ambient light enters the display system. In some embodiments, the entrance aperture optics is configured to collect as much light as possible and may include diffractive optic elements, Fresnel lens or surfaces, nanocone or nanopillar arrays, antireflection layers, and the like.

The terms “field evolving cavity” or “FEC” refer to a non-resonant (e.g., unstable) cavity, comprising reflectors or semi-reflectors, that allows light to travel back and forth between those reflectors or semi-reflectors to evolve the shape of the wavefront, and consequently the monocular depth, associated with the light in a physical space. One example of an FEC may comprise two or more half-mirrors or semi-transparent mirrors, facing each other and separated by an air-gap or dielectric of distance d. The light that travels from the first half-mirror, reflected by the second half-mirror, reflected by the first half-mirror, and finally transmitted by the second half-mirror will have traveled a total distance of 2d, which is the monocular depth. Thus, the monocular depth is larger than the length of the FEC. If, for example, the source of light is a pixel, which is approximately a point source, the FEC causes the spherical wavefront of the pixel to be flatter than it would be if the light traveled once through the gap.

In some embodiments, an FEC may be parallel to or optically coupled to a display or entrance aperture optics (in the case of display systems that use ambient light as the light source) or to an imaging aperture or imaging aperture (in the case of imaging systems). In some embodiments, an FEC changes the apparent depth of a display or of a section of the display.

As another non-limiting example, an FEC comprises a reflector and a semi-reflector oriented at an angle to the reflector. The semi-reflector receives and reflects light from a light source and directs it toward the reflector. The reflector receives said light, then reflects it toward the semi-reflector, which (partially) transmits the light to the outside world, towards a viewer. In an FEC, a round trip occurs once the light completes one cycle and comes back to the first (semi-) reflective component.

In some embodiments, a “round trip” occurs when light substantially reverses direction to interact with an element of an optical system more than once. The term “round trips” denotes the number of times that light circulates or bounces back and forth between two cavity elements or the number of times light interacts with a single element.

FECs can have infinitely many different architectures, but the principle is always the same. An FEC is an optical architecture that creates multiple paths for the light to travel, either by forcing the light to make multiple round trips or by forcing the light from different sections of the same display (e.g., a segmented display) to travel different distances before the light exits the cavity. If the light exits the cavity perpendicular to the angle it has entered the cavity, the FEC is referred to as an off-axis FEC or a “FEC with perpendicular emission.”

An FEC assists in providing depth cues for three-dimensional perception for a user. In some embodiments, a depth cue is a monocular depth cue. The number of round trips is arbitrarily engineered. For example, there may be 0, 1, 2, or 3 round trips. The number of round trips substantially determines the monocular depth perceived be a viewer. In some embodiments, a monocular depth is larger than the distance between the viewer and the light source. For example, the ratio between the monocular depth and the distance may be 1, 1.1, 1.5, 2, 2.5, 3, 4.5, or 5. In some embodiments, the ratio may lie within a range, such as between 1 and 2, between 1 and 4, between 2 and 4, or greater than 2. In some embodiments, a monocular depth is dynamically adjustable by modifying a property of the virtual display system.

In some embodiments, polarization-dependent and polarization impact elements-such as polarizers, wave plates, and polarizing beam splitters—may be used to increase the light efficiency or modify the number of round trips. In some embodiments, different light rays travel different total distances to produce multiple focal planes, or a multi-focal image, which has a plurality of image depths. In some embodiments, an image depth is dynamic or tunable via, e.g., electro-optic structures that modify the number of round trips.

The “light efficiency” or “optical efficiency” is the ratio of the light energy the reaches the viewer to the light energy emitted by an initial display.

Throughout this disclosure, “angular profiling” is the engineering of light rays to travel in specified directions. Angular profiling may be achieved by directional films, holographic optical elements (HOEs), diffractive optical elements (DOEs), lenses, lenslet arrays, microlens arrays, aperture arrays, optical phase masks or amplitude masks, digital mirror devices (DMDs), spatial light modulators (SLMs), metasurfaces, diffraction gratings, interferometric films, privacy films, or other methods. “Intensity profiling” is the engineering of light rays to have specified values of brightness. It may be achieved by absorptive or reflective polarizers, absorptive coatings, gradient coatings, or other methods. The color or “wavelength profiling” is the engineering of light rays to have specified colors, or wavelengths. It may be achieved by color filters, absorptive notch filters, interference thin films, or other methods. “Polarization profiling” is the engineering of light rays to have specified polarizations. It might be achieved by metasurfaces with metallic or dielectric materials, micro- or nanostructures, wire grids or other reflective polarizers, absorptive polarizers, quarter-wave plates, half-wave plates, 1/x waveplates, or other nonlinear crystals with an anisotropy, or spatially profiled waveplates. All such components can be arbitrarily engineered to deliver the desired profile.

A “transversely varying optical property” is an optical property—intensity, spectrum/color, polarization, phase, and the like—that varies across a lateral dimension of a beam of light. For example, in a conventional image, the bright and dark regions correspond to a transversely varying intensity. The embodiments disclosed herein produce transversely varying optical properties on image-forming light of display systems, particularly in virtual display systems. In some embodiments that produce multifocal images, the transversely varying optical property impacts a display content at one particular focal plane, or it is based on a display content at a second focal plane.

“Distortion compensation” is a technique for compensating errors in an optical system that would otherwise degrade image quality. In some embodiments, the distortion compensation is computational. The desired image content is pre-distorted such that when it experiences a physical distortion, the effect is negated, and the result is a clear image. Distortions to compensate include aberrations, angular variations of reflections. For example, a birefringent or anisotropic element may be added to account for an angle-dependent response of a wave plate. Such elements are called compensators or C-plates. Distortion compensation may also be effected computationally. For example, if a virtual display system produces a barrel distortion, a pre-computed image may include a pincushion-type distortion, such that the net effect is an image with minimal or zero barrel or pincushion distortion. Another type of distortion correction is perspective distortion correction. Other types of distortion compensation include perspective distortion compensation, which pre-compensates skewed based on off-axis reflections of optical elements. This can be pre-compensated using a homography transformation, keystone correction, and the like.

For example, the virtual image may have a barrel distortion that is produced by the nonuniform magnification of different elements of the image as they travel through a field-evolving cavity. The barrel distortion may be modeled as a function that transforms the image according to a polynomial function, such as f(r)=r(1−kr²), where r is the radial distance from the center of the image, and k is a system parameter. To pre-compensate this barrel, distortion, the inverse function g may be applied to the display content itself, where g(r)=r/(1−kr²). To apply this to the image, an algorithm may determine the pixel size of the display content, calculate the center pixel, create a matrix of the same pixel size of the image, and use g(r) to map each pixel value of the original display content to an element in the matrix. The radial distance is calculated by calculating the pixel distance between the pixel to be mapped and the center pixel. When all the pixels have been mapped, the matrix then becomes the new display content that is pre-compensated. The actual functions f and g depend on the specific configuration and shapes of the optics elements in the display system. Other types of compensation algorithms may use an inverse function, look-up table, machine learning algorithm, or neural network. In some embodiments, the pre-compensation may affect the intensities of the pixels or the color profile.

All such components and software can be arbitrarily engineered to deliver the desired profile. As used herein, “arbitrary optical parameter variation” refers to variations, changes, modulations, programing, and/or control of parameters, which can be one or a collection of the following variations: bandwidth, channel capacity, brightness, focal plane depth, parallax, permission level, sensor or camera sensitivity, frequency range, polarization, data rate, geometry or orientation, sequence or timing arrangement, runtime, or other physical or computational properties. Further parameters include optical zoom change, aperture size or brightness variation, focus variation, aberration variation, focal length variation, time-of-flight or phase variation (in the case of an imaging system with a time-sensitive or phase-sensitive imaging sensor), color or spectral variation (in the case of a spectrum-sensitive sensor), angular variation of the captured image, variation in depth of field, variation of depth of focus, variation of coma, or variation of stereopsis baseline (in the case of stereoscopic acquisition).

The “optic axis” or “optical axis” of a display (imaging) system is an imaginary line between the light source and the viewer (sensor) that is perpendicular to the surface of the aperture or image plane. It corresponds to the path of least geometric deviation of a light ray.

Throughout this disclosure, “transverse invariance” or “transversely invariant” are terms that refer to a property that does not vary macroscopically along a dimension that is perpendicular to the optic axis of that element. A transversely invariant structure or surface does not have any axis of symmetry in its optical properties in macro scale.

A “photoresponsive” material, layer, or element is one whose properties change based on incident light. In some embodiments, the property is an electrical property, such as resistance, potential difference, surface charge, induced current, and the like. A photoconductive material is a photoresponsive material whose conductance (or, reciprocally, resistance) changes where it is exposed to light. Photoconductive materials include cadmium sulfide, cadmium selenide, other cadmium-based materials, amorphous-hydrogenated-silicon, zinc oxide, zinc selenide, lead sulfide, lead selenide, GaAs, other doped and undoped semiconductors, conductive polymer polyvinyl carbazole and other photoconductive polymers, and the like. Other examples include 2D/van der Waals materials/transition metal dichalcogenides, such as MoS₂, WS₂, hBN, other MX₂ materials (where M is a transition metal, and X is a chalcogen atom), (twisted or biased) graphene, and the like. In some embodiments, the same or similar materials may enable a photoresponse as a semiconductor pn or pin junction architecture. In some of these embodiments, the electrical property is the electric field in the depletion region. In some embodiments, these materials are individual slabs, elements, or layers. In other embodiments, they are in particulate form and dispersed in a substrate, e.g., as nanoparticles in a liquid crystal.

A photovoltaic (PV) material is a photoresponsive material that generates electrical potential difference across it when exposed to light. In some embodiments, the PV material is transparent PVs. Some PV materials include organic PVs, poly(3-hexylthiphene), fullerenes like PCBM, various perovskites (such as cesium lead halide perovskites), various dye-sensitized solar cells, and the like. In some embodiments, the photoresponsive materials are one or more narrowband perovskites. In some embodiments, the PV is rendered transparent via a dye-sensitization process

Note that a photoresponsive material might be used in different ways, e.g., as a PV or a photoconductor or a transparent electrode, depending on the configuration.

A “thin film” is a subwavelength-thick film or layer. Multilayer films comprise multiple thin films. Some films may be birefringent. In some embodiments, one or more layers are switchable, such as an LC thin film. Thin films and multilayer films may be coated onto solid substrates or other optical components.

A “programming element,” layer, or material is one whose properties can be transversely patterned or modified by a source such that when the source is incident on it locally, its properties change at that local position. Programmable layers are distinct from elements whose property change is global, i.e., occurs across the entire, or most of the element in a uniform way. For example, a polarizer, wave plate, semi-reflector, and the like are not light modulation layers because their responses are intended to be fixed. On the other hand, when one of those elements has higher-order properties, such as an optical nonlinearity, then the interaction may convert it into a programming element. Effectively, the programming element generates a transverse pattern that is coupled to a “modulation element,” layer, or material. Which is an element that receives the pattern of the programming element and transfers it to image-forming light. The nature of the coupling is arbitrary. For example, it may be optically coupled, thermally coupled, magnetically coupled, electrically coupled, mechanically coupled, and the like. In some embodiments, the programming and modulation elements are one in the same. This may be the case when the programming material is doped within the a substrate of the modulating material, or when a single material is both programmable by a source and able to imprint a pattern onto image-forming light.

The terms “meshless optic, “meshless mask,” and the like refer to the combination of a programming element and modulation elements or materials that imprint a pattern onto image-forming light without an addressable matrix. In some embodiments, the term includes the secondary source that produces the pattern. The meshless optic is the subsystem that modifies a transversely varying optical property of light, particularly of image-forming light. The lateral size of the image is determined at least in part by the lateral sizes of the components of the meshless optic. In some embodiments, a lateral image size is greater than 5 cm, greater than 10 cm, greater than 15 cm, or greater than 20 cm.

“Diffractive artifacts” are artifacts that are caused by pixelated structures or addressable matrices. These include image pixelation, rainbow effects, diffracted waves at different grating orders, and the like. Generally, they distort the ideal image and are unwanted. A meshless optic serves to imprint a pattern onto image-forming light without introducing diffractive artifacts. Such diffractive artifacts are farfield diffractive artifacts and would be viewed by a viewer of a display system.

As used herein, “imaging system” refers to any apparatus that captures an image, which is a matrix of information about light intensity, phase, temporal character, spectral character, polarization, entanglement, or other properties used in any application or framework. Imaging systems include cellphone cameras, industrial cameras, photography or videography cameras, microscopes, telescopes, spectrometers, time-of-flight cameras, ultrafast cameras, thermal cameras, or any other type of imaging system. In some embodiments, the gesture that is output can be used to execute a command in a computer system connected, wireless or by hardwire, to the gesture camera.

Some capabilities described herein may be implemented in one or more modules. A module comprises the hardware and/or software, to implement the capability. For example, such a capability may be implemented through a module having one or more processors executing computer code stored on one or more non-transitory computer-readable storage medium. In some embodiments, a capability is implemented at least in part through a module having dedicated hardware (e.g., an ASIC, an FPGA). In some embodiments modules may share components. For example, a first function module and a second function module may both utilize a common processor (e.g., through time-share or multithreading) or have computer executable code stored on a common computer storage medium (e.g., at different memory locations).

In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure hardware such as an FPGA. In some embodiments, the information for implementing capabilities such as functions, visual templates, graphical user interfaces, input stream reception, and input stream generation may be recorded as a software module. The capability may be implemented, for example, by reading the software module from a storage medium and executing it with one or more processors, or by reading the software module from a storage medium and using the information to configure hardware.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in numerous ways. Different combinations and sub-combinations are intended to fall within the scope of this disclosure, and certain method or process blocks may be omitted in some implementations. Additionally, unless the context dictates otherwise, the methods and processes described herein are also not limited to any sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine but deployed across several machines.

This disclosure extends previous methods display systems which produce a single, continuous lightfield that enables simultaneous detection of monocular depth by each eye of a viewer who is positioned within the intended viewing region, where both the monocular depth can be greater than the physical distance between the display and the viewer, and where the apparent size of the display (as perceived by the viewer) is larger or smaller than the physical size of the display.

The methods in this disclosure can be used in arbitrarily engineered displays. These include, but are not limited to, large-scale lightfield displays that doesn't require glasses, systems that do require glasses, display systems that curve in front of the face and are closer to the user, lightfield displays with fractional lightfield, any type of head-mounted displays such as AR displays, mixed reality (MR) displays, VR displays, and both monocular and multifocal displays.

Further, the methods in this disclosure can be used in arbitrarily engineered imaging systems, including, but not limited to, microscopes, endoscopes, hyperspectral imaging systems, time-of-flight imaging systems, telescopes, remote imaging systems, scientific imaging systems, spectrometers, and satellite imagery cameras.

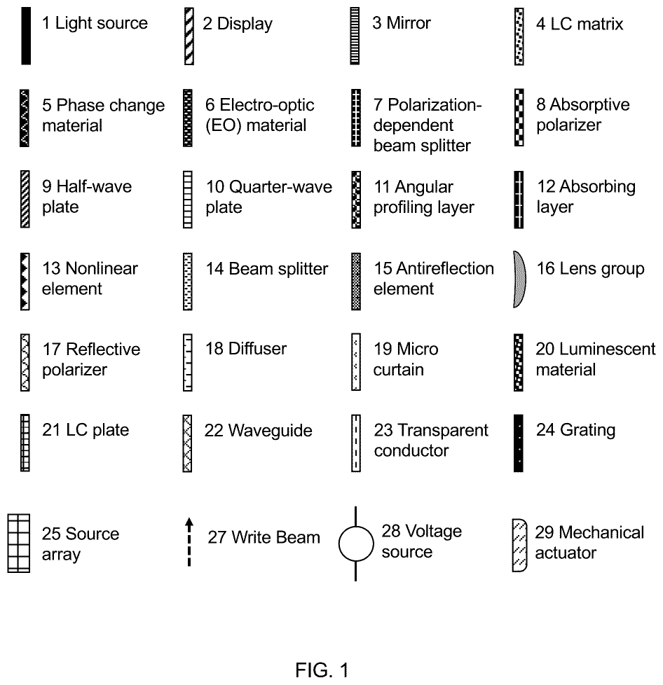

FIG. 1 depicts a set of elements that represent the fundamental components and structures of the embodiments disclosed herein.

A light source 1 is any component or structure that emits light. In some embodiments, the light source generates an image. In some embodiments, the emitted light is an optical system to impact another component or structure. The light source may be one or more lasers, one ore more light emitting diodes (LEDs), a backlight, a display panel, and the like. The intensity, polarization, luminance, angular profile, and spectrum can be arbitrarily engineered. In some embodiments, its properties change during its operation. For example, a laser beam scanner is a light source whose beam direction changes in time.

A display 2 is a light source that produces an image. In this disclosure, the term “display” can be based on any technology, including, but not limited to, display panels likes liquid crystal displays (LCD), thin-film transistor (TFT), light emitting diode (LED), organic light emitting diode arrays (OLED), active matrix organic light emitting diode (AMOLED), micro LED, plastic organic light emitting diode (POLED), micro organic light emitting diode (MOLED), or projection or angular-projection arrays on flat screens or angle-dependent diffusive screens or any other display technology and/or mirrors and/or half-mirrors and/or switchable mirrors or liquid crystal sheets arranged and assembled in such a way as to exit bundles of light with a divergence apex at different depths or one depth from the core plane or waveguide-based displays. The display may be an autostereoscopic display that provides stereoscopic depth with or without glasses. It might be curved, flat, or bent; or comprise an array of smaller displays tiled together in an arbitrary configuration. The display may be a near-eye display for a headset, a near-head display, or far-standing display.

The spectrum of a display is arbitrary. For conventional images or virtual display systems, the display panels usually emit white light, which contains enough spectral components (e.g., red, blue, and green) such that the image is perceived as a white-light image or a full-color image.

A “segmented display” is a display in which different portions of the display show different display contents, i.e., a first portion of light from the segmented display corresponds to an independent display content compared to a second portion of light from the segmented display. In some embodiments, the light corresponding to each display content travels a different path through an optical system to produce correspondingly different virtual images. The virtual images may be at different monocular depths. Each display content is called a “segment.” In some embodiments, the different segments show identical content that are made to overlap to enhance brightness or another property of the image quality.

A “display system” is any device that produces images. Physical sources of display images can be standard 2D images or video, as produced by a display panel or a plurality of display panels. Such display technologies, or a plurality of them, may also be incorporated into other display systems. In some embodiments, spatial light modulators (SLMs) are used. In some display systems, light sources may be coupled with masks or patterned elements to make the light source segmented and addressable. Other sources may be generic light sources, such as one or several LEDs, backlights, or laser beams, configured for use, for example, in projection-based display systems. A display system may be a headset, a handheld device, or a free-standing system, where the term “free-standing” means that the device housing can rest on a structure, such as a table. In some embodiments, the display system is configured to be attached to a structure by a mechanical arm.

A mirror 3 is a specular reflector that reflects light with high reflectivity. Mirrors may be curved, flat, or free-formed to an arbitrary geometry shape. A mirror may alternatively be called a “reflector.” In some embodiments, the reflectivity of the mirror is due to a surface effect. In some embodiments, the reflectivity is due to a bulk effect or to the joint effect of multilayer films. For example, a dielectric stack of thin films functions as a mirror in some embodiments.

A liquid crystal (LC) matrix 4 is an addressable matrix comprising an array of electrically addressable LC cells, or pixels. The pixels of the of the LC matrix modulate the polarization of the incident light, such that a subsequent polarizer converts the polarization changes to intensity changes to produce an image.

A phase change material (PCM) 5 is one whose phase and optical properties change with the application of a thermal source. An example is VO₂, various GexSeyTez (GST-XYZ) compounds (e.g., GST-225), various Ge_{W}SB_{X}Sc_{Y}Te_{Z} (GSST-WXYZ) compounds (e.g., GSST-2214). In some embodiments, the VO₂ is dispersed in a substrate. Other PCMs include XVO₃ materials (X=Sr, Ba, Mg), SrNbO3, various chalcogenide glasses (GeSbTe or AgInSbTe), certain sulfides (tin sulfide or antimony sulfide), certain oxides (tungsten oxide, or nickel oxide), and the like. The thermal source can be arbitrarily engineered. For example, the thermal source may come from thermal radiation or contact, optical or electromagnetic absorption, thermo-electric coupling, and the like. Further, the phase change itself may be, for example, between amorphous and crystalline states, or between conductor and semiconductor states. (Some of these materials also may serve as photoconductive materials that absorb in the IR to change the conductivity and is relatively transparent to visible or are very narrowband absorbers.)

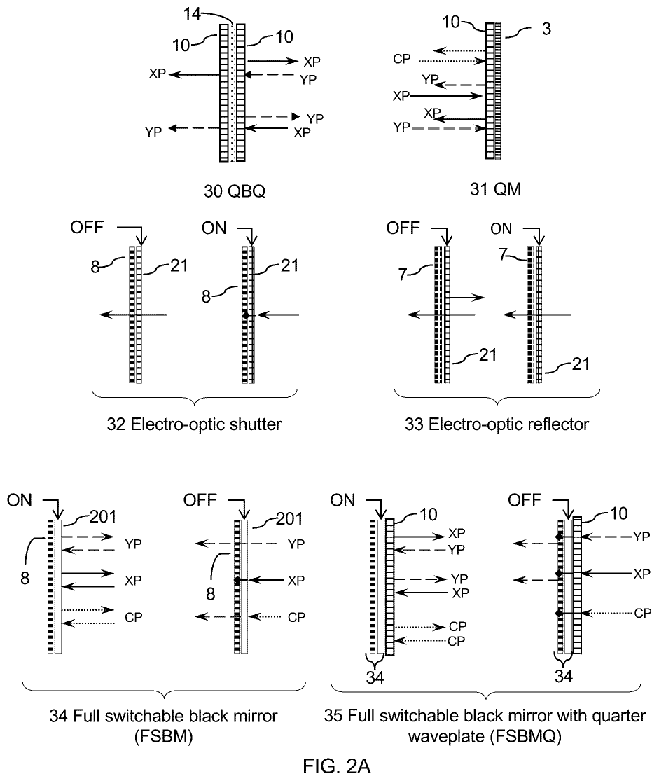

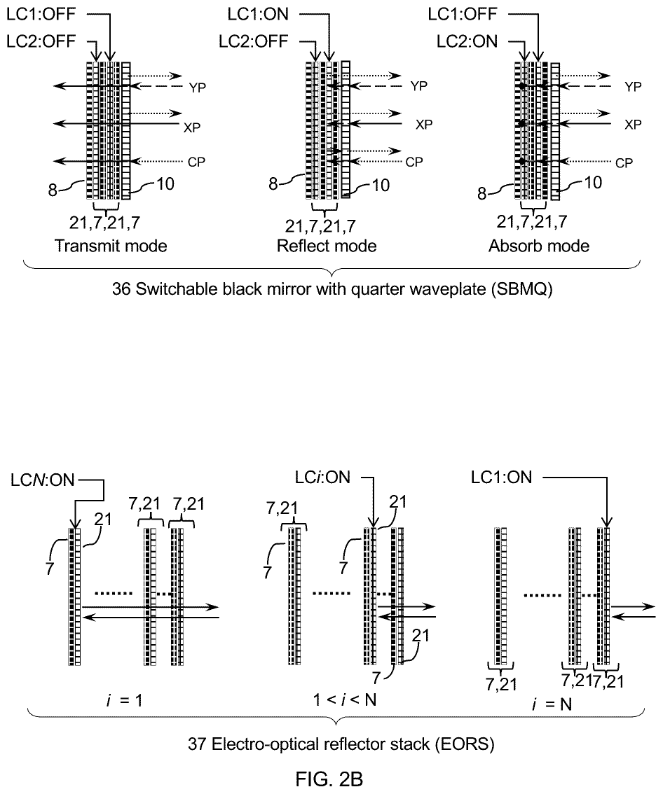

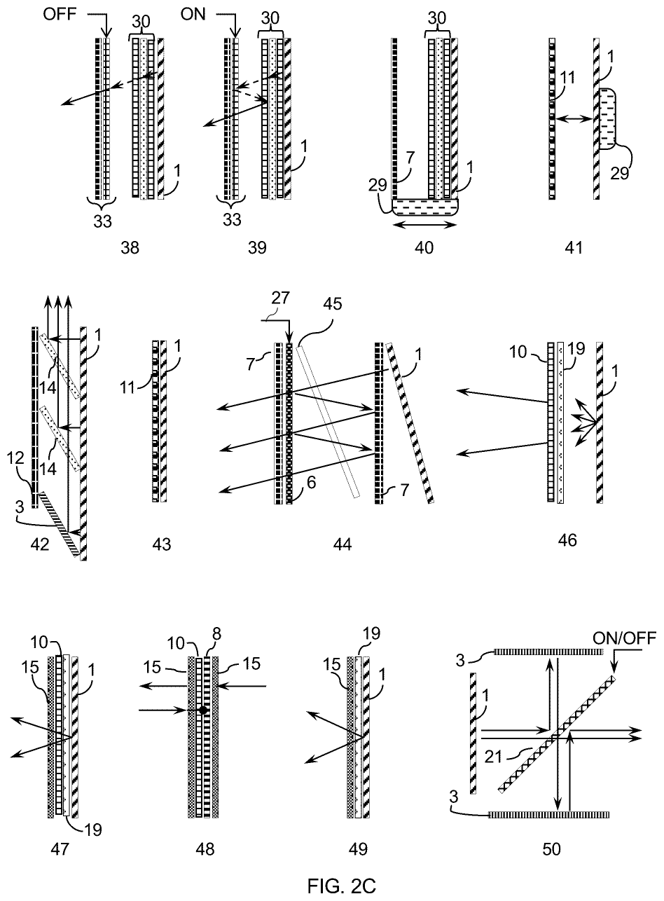

An electro-optic (EO) material 6 is a material whose refractive index changes with the application of an electric field. It is an example of a nonlinear element because the electric field may be caused incident light, which can experience that index change or cause a different light source to experience it. A photorefractive material is an example of an electro-optic material. When the field is caused by an external applied voltage, it is an active element. Throughout this disclosure, the terms “active design,” “active components,” or, generally, “active” refer to a design or a component that has variable optical properties that can be changed with an optical, electrical, magnetic, or acoustic signal. Electro-optical (EO) materials include liquid crystals (LC); liquid crystal as variable retarder (LCVR); or piezoelectric materials/layers exhibiting Pockel's effects (also known as electro-optical refractive index variation), such as lithium niobate (LiNbO₃), lithium tantalate (LiTaO₃), potassium titanyl phosphate (KTP), strontium barium niobate (SBN), and β-barium borate (BBO), with transparent electrodes on both sides to introduce electric fields to change the refractive index. The EO material can be arbitrarily engineered. Conversely, “passive designs” or “passive components” refer to designs that do not have any active component other than the display. EO materials include the EO-based subassemblies in FIGS. 2A and 2B.

A polarization-dependent beam splitter (PBS) 7 reflects light of one polarization and transmits light of the orthogonal polarization. A PBS can be arbitrarily engineered and made using reflective polymer stacks, nanowire grids, or thin-film technologies. Other PBSs include PBS cubes. In some embodiments, a PBS is interchangeable with a reflective polarizer.

An absorptive polarizer 8 transmits light polarized along its pass angle and absorbs cross polarized light.

A half-wave plate (HWP) 9 is a wave plate that produces a relative phase shift of 180 degrees between perpendicular polarization components that propagate through it. For linearly polarized light, the effect is to rotate the polarization direction by an amount equal to twice the angle between the initial polarization direction and the axis of the waveplate. In some embodiments, horizontally polarized light is converted to vertically polarized light, and vice versa, after transmission through an HWP.

A quarter-wave plate (QWP) 10 is a wave plate that produces a relative phase shift of 90 degrees. It transforms linearly polarized light into circularly polarized light, and it transforms circularly polarized light into linearly polarized light.

An angular profiling layer 11 is an arbitrarily engineered layer to produce a specified angular distribution of light rays. In some embodiments, it allows the transmission of rays within a certain range of incident angles, whereas rays outside such a range of angles are blocked. In some embodiments an angular profiling layer is a directional film or layer. This element selectively transmits light rays that are oriented at angles within a specified angular range and blocks light rays directed outside that range. For example, the directional film may transmit light rays that are incident within a range from zero to 10 degrees, zero to 20 degrees, zero to 30 degrees, zero to 40 degrees, zero to 50 degrees, or zero to 60 degrees. In some embodiments, the directional film tilts the chief ray of the light source. The directional film does not provide optical (focusing) power. In some embodiments, the directional film transmits an angular range that does not start at zero degrees. The directional film may be placed after a display. Another angular profiling layer example is a lenslet array. The lenslet array may be used in conjunction with a directional film to help focus or collimate the light. The lenselt array may be a microlens array. Each lenselt be approximately the size, or smaller, than a pixel of a display.

An absorbing layer 12 is a material or element that absorbs light. In some embodiments, it is a black paint or coating. In some embodiments, it is vantablack.

A nonlinear element 13 is a material whose optical response is modified or impacted by light. Photorefractive elements are nonlinear. The nonlinear material is sometimes defined by the form of the nonlinearity, for example, a temporal or spatial nonlinearity, a Kerr-type, saturable-type, or higher-order nonlinearity. Nonlinear elements may be of different phases (e.g., solid, liquid, gas, plasma, and the like). Nonlinearities include harmonic generation, sum or frequency generation, rectification, and the like.

A beam splitter 14 is a specular reflector that partially reflects and partially transmits incident light. The ratio of reflected light to transmitted light can be arbitrarily engineered. In some embodiments, the transmission-to-reflection ratio is 50:50. In some embodiments, the transmission-to-reflection ratio is 70:30. A beam splitter is a semi-reflective layer that reflects a certain desired percentage of the intensity and transmits the rest of the intensity. A simple example of a beam splitter is a glass plate with a semi-transparent silver coating or dielectric coating on it, such that it allows 50% of the light to pass through it and reflects the other 50%. The term “semi-reflector” is used interchangeably.

Generally, both mirrors and beam splitters are used to direct light along a proscribed path in a display system. Both rely on specular reflection because their surfaces are smooth on the order of a wavelength. The term “specular reflector” therefore refers to both mirrors and beam splitters. The main difference is only the relative amount of light that is reflected. For example, with a perfect mirror, all the light is reflected, whereas in a standard beam splitter, about half the light is reflected. Though, a beam splitter may be designed to reflect other fractions of the light such as, for example, about 25% or 75%. How much light is reflected, the reflectance, may also vary by wavelength or polarization.

An antireflection (AR) element 15 eliminates reflections of light incident on its surface. A microstructure such as a nano-cone layer may be an AR element. In some embodiments an AR element is a thin-film coating.

A lens group 16, which consists of one or multiple lenses of arbitrary focal length, concavity, and orientation. In some embodiments, a lens group forms a real image on an imaging sensor.

A reflective polarizer 17 transmits light polarized along its pass angle and reflects cross polarized light. A wire grid polarizer (a reflective polarizer made with nano wires aligned in parallel) is an example. The reflectivity and transmittivity depends on the angle of the incident light.

A diffuser 18 scatters light in a random or semi-random way. A diffuser can be a micro-beaded element/array or have another microstructure. Diffusers may reflect scattered light or transmit scattered light. The angular profile of the light may be arbitrarily engineered. In some embodiments, light scattered by a diffuser follows a Lambertian profile. In some embodiments, the light scattered forms a narrower profile.

A micro-curtain 19 redirects light into specified directions or shields light from traveling in specified directions. A micro curtain can be made by embedding thin periodic absorptive layers in a polymer or glass substrate, or it can be made by fusing thin black coated glass and cutting cross-sectional slabs.

A luminescent material 20 emits light. In some embodiments, the luminescence is phosphorescence, or it is fluorescence, which are “photoluminescent” materials. Luminescent materials' light emission may be caused by the absorption of light, usually at a different wavelength. In some embodiments, there is IR to visible up conversion. In some embodiments, the fluorescent particles comprise quantum dots, such as CdS. In some embodiments the photoluminescent materials are activated, switched, or otherwise modified by another light source. A “quantum dot” (QD), or “quantum-dot layer,” is a fluorescent particle light source, or an element containing a plurality of such light sources, which are based on the absorption and emission of light from nanoparticles in which the emission process is dominated by quantum mechanical effects. These particles are a few nanometers in size, and they are often made of, but not limited to, II-IV semiconductor materials, such as cadmium sulfide (CdS), cadmium telluride (CdTe), indium arsenide (InAs), or indium phosphide (InP). When excited by ultraviolet light, an electron in the quantum dot is excited from its valence band to its conduction band and then re-emits light as it falls to the lower energy level. In some embodiments, QD spectra are modified by structure, morphology, temperature, strain.

Other luminescent materials or elements may be photoactivated or photoswitchable, which is activated to absorb light at a first wavelength and emit it at a second wavelength only in the presence of a third wavelength. Photoswitchable and photoactivated materials include fluorescent proteins such as PA-GFP, PAmKate, Denddra₂, Kacde, EosFP, Dronpa, Kindling FP, and the like. The absorption, emission, and activation spectra can be arbitrarily engineered. Further examples include azobenzenes, spiropyrans, and diarylethenes, as well as donor-acceptor Stenhouse adducts, phototropic organic metals or metal oxides, some QDs, perovskites, and some ruthenium, iron, or cobalt complexes.

An LC plate (21) is a uniform LC slab or thin film. In the “ON” state, the LC plate rotates the polarization of the light that passes through it. In the “OFF” state, the state of the light polarization is unchanged upon transmission through the layer. In some embodiments the LC is a nematic twisted crystal. In some embodiments, the LC plate is doped with other particles or elements, such as quantum dots, resonant nanoparticles, and the like. In some embodiments, the doped particles are fixed in place, such as conducting rods that extend from one side to the other. Such an architecture effectively provides conductivity to the LC and allows current to pass through it. In some embodiments the LCs are slightly conducting. In some embodiments, either the programming layer or the modulation layer comprises a photorefractive or other EO materials. In some embodiments, the LC is dye-doped LC (methyl-red), but this may be too slow for certain applications. The LC may be of any type: ferroelectric, twisted nematic, cholesteric, etc. In some embodiments, the material is an LC-PR hybrid material. In some embodiments, the LC is doped randomly with nanospheres, subwavelength structures, or other particles.

The LC plate may be of any type: twisted nematic, cholesteric, ferroelectric, nematic, smectic, discotic, and the like. Its specific structure and orientational/geometric properties can be arbitrarily engineered to produced the desired electro-optic effect. In some embodiments, an LC plate comprises layers of individual LC plates stacked on top of each other.

A waveguide 22 is a structure to guide light along a direction. In some embodiments, a display is formed by optically coupling a light source, such as a backlight, to a waveguide. In some embodiments, the waveguide comprises multiple waveguides or is wavelength dependent.

A transparent conductor 23 is a material, that has simultaneously high optical transparency and good electrical conductivity. In some embodiments, a transparent conductor is a semiconducting material, which may be doped. For example, indium tin oxide (ITO) is a transparent conductor. Other transparent conductors include graphene, silver or cupper nanowires, carbon nanotubes, MoO₃, aluminum- or gallium-doped zinc oxide, and boron-doped diamond. Note that a transparent conductor may also be a transparent semiconductor.

A grating 24 is a corrugated structure to scatter light into specific directions. The corrugated structure is typically on the order of the wavelength of light, e.g., between 400 nm and 1000 nm, such that diffraction effects cause the scattering. In some embodiments, gratings are periodic. In some embodiments, a grating is a surface grating etched onto a substrate to in-couple or out-couple light into or out of the substrate.

A source array 25 is a collection of sources of optical energy/light, thermal energy, acoustic waves, radio-frequency (RF) or other alternating electronic signals, static or nearly-static voltages, mechanical vibrations, and the like. In some embodiments, the elements in a source are identical to each other. For example, a set of identical electrodes, each of which may independently generate or produce its own potential, is a source array. A source array includes a set of light sources, such as lasers. Usually, a source array has more than two elements.

A write beam 27 is the light from a light source that is used to modulate a component or subsystem of the embodiments disclosed herein. In some embodiments, the write beam is emitted from the same light source that generates images.

A voltage source 28 is a source of electric voltage. In some embodiments, it is a power supply, a battery, an alternating current (AC) signal, or an electronic signal.

A mechanical actuator 29 physically moves the elements to which are connected via an electrical or other types of signals.

FIGS. 2A through 2C show how the basic elements in FIG. 1 can be combined to produce structures, elements, architectures, subassemblies, or sub-systems. In some embodiments, these are integrated into a single, monolithic element, e.g., when a substrate is coated with various films or coatings. In some embodiments, they may be discrete components arranged with or without air gaps between them. In FIG. 2A, a QBQ 30 comprises a QWP 10, a beam splitter 14, and another QWP 10. Light incident on a QBQ is partially reflected and partially transmitted, and the QBQ acts as a HWP for both the reflected and transmitted portions, converting x-polarized light (XP) into y-polarized light and vice versa. In some embodiments the beam splitter is a PBS. A QM 31 comprises a QWP 10 and a mirror 3. It reflects all light, and it converts x-polarized light into y-polarized light and vice versa (or, equivalently, horizontally polarized light into vertically polarized light). It does not change the polarization state of circularly polarized light.

An electro-optic shutter 32 comprises an LC plate 21 and an absorptive polarizer 8. When the LC plate is ON, it rotates the polarized incident light such that it is aligned perpendicular to the absorptive polarizer and is absorbed by it. When the LC plate is OFF, it leaves the polarization unchanged and parallel to the absorptive polarizer which transmits it. An electro-optic reflector 33 comprises an LC plate 21 and a PBS 7. When the LC plate is ON, it rotates the polarization such that it aligned along the transmit orientation of the PBS. When the LC layer is OFF, the light passing through it is aligned such that the PBS reflects it.

A fully switchable black mirror (FSBM) 34 comprises an absorptive polarizer 8 and a full switchable mirror 201, which may be an EO material. In the ON state, the full switchable mirror 201 is on and reflects light of all polarizations. In the OFF state, the switchable mirror transmits the light, and an absorptive polarizer 8 extinguishes x-polarized light, transmits y-polarized light, and transmits only the y-component of circularly polarized light. A full switchable black mirror with quarter waveplate (FSMBQ) 35 comprises an FSBM 34 and a QWP 10. In the ON state, it reflects all light and interchanges x-polarized with y-polarized light (and vice versa). It reflects circularly polarized light without changing the polarization. In the OFF state it extinguishes circularly polarized light, transmits y-polarized light, and coverts x-polarized light into y-polarized light and transmits the result.

Shown in FIG. 2B are two switchable reflective stacks. A switchable black mirror with quarter waveplate (SBMQ) 36 comprises a QWP 10, followed by two alternating layers of LC plates 21 and PBSs 7, and finally one absorptive polarizer 8. The difference between the FSBMQ and the SBMQ is their corresponding polarization dependence. In the former the total reflectivity of the material is changing, agnostic to the polarization of the incident light, whereas the latter element produced a polarization-dependent reflectivity.

For the SBMQ 36, when both LC plates are OFF (“transmit mode”), all incident polarizations transmit an x-polarized component; incident linear polarization reflect circular polarization. Incident circular polarization reflects light that depends on whether it is right- or left-circularly polarized. When the first LC plate is ON and the second OFF (reflect mode), all light is reflected as circularly polarized. When the plate LC plate is OFF and the second LC is ON (absorb mode), incident light that strikes the absorptive layer and is extinguished, and no light is transmitted through the layers.

An electro-optical reflector stack (EORS) 37 comprises a stack of N alternating PBS 7 and LC plates 21. All but one LC plate is in the OFF state, and the LC plate that is in the ON state reflects the incident x-polarized light. All other layers transmit light. By varying which LC layer is in the ON state, the EORS modulates the optical depth or optical path or the length that the light must travel through the stack before it is reflected by a cross-polarized PBS layer next to the ON LC layer. In some embodiments the LC plates and PBSs are configured to reflect y-polarized light.

It should be noted that the EO shutter 32, the EO reflector, the FSBM 34, the FSBMQ, the SBMQ 36, and the EORS 37 are all electro-optic and therefore may be used as an electro-optic programming element or modulation element.

Shown in FIG. 2C are further combinations of elements. In some embodiments, these form a variety of field evolving cavities (FEC) or layer stacks that can be used as subsystems for architectures explained throughout the disclosure. 38 and 39 are OFF and ON states, respectively, of a display 1 and QBQ 30 followed by an electro-optic reflector 33. In the OFF state, the light directly exits the device to be viewed by an observer. In the ON state, the light is forced to travel one round trip in the cavity, and the displayed image appears to be deeper compared to the actual location of the display. In some embodiments, the monocular depth of the resulting image is approximately twice as far as that of the display itself. 40 is a display 1 followed by a QBQ 30 and a PBS 7 set on a mechanical actuator 29. The actuator shifts the set of layers to create longer or shorter optical path lengths for the light and hence shorter or longer monocular depths. 41 is a mechanical actuator 29 fixed to display 1. The actuator can shift the display relative to an angular profiling element 11 to force the light to change directionality or to become collimated. In some embodiments, the angular profiling layer is a lenslet array such that the mechanical movement of the display changes the object distance and therefore impacts the collimation. In some embodiments, the display is “macro-formed,” meaning it may have mechanical waves or bends induced onto it by the mechanical actuators so that the directionality or collimation of the light that comes out of the angular lenslet array is impacted in a desired way. In some embodiments other elements, such as a beam splitter or mirror, are macro-formed.

In some embodiments, the display is mechanically shifting, because of the actuator's motion along a translational axis, again to impact the directionality of the exit light from the apertures. The mechanical actuation mechanism may be arbitrarily engineered. In some embodiments, the mechanical actuator is an array of ultrasonic transducers; in some embodiments, the mechanical translation is performed by a high rotation-per-minute brushless motor; in some embodiments, the mechanical movements are delivered via a piezo- or stepper motor-based mechanism.

An example of one type of FEC 42 consists of display 1 that is partitioned into segments, i.e., a segmented display. Light from the bottom segment is reflected by a mirror 3, and light from the upper segments is reflected by subsequent beam splitters 14. An absorptive matrix 12 absorbs unwanted stray light. In some embodiments the absorptive matrix is a uniform attenuator to substantially absorb all the light incident on it uniformly across its surface. This is an example of an off-axis FEC. In some embodiments, the FEC produces a multifocal image. The FEC can be arbitrarily engineered to represent the desired number of focal planes.

Precavity optics 43 consists of display 1 layer followed immediately by an angular profiling element 11, which may be a directional film here. The angular profiling layer might be a lenticular lens array to provide stereopsis to the viewer, or it might be a lenslet array or any other angular profiling layer to provide autostereoscopic 3D or provide different images to different angles.

In some embodiments, the precavity optics comprises different elements to achieve the desired profiling. Such modified precavity optics may have fewer or more components.

An example of a tilted FEC 44 is an angled display 1, followed by a FEC comprising an “internal polarization clock” whose ends are composed of PBSs 7. In between the PBSs 7 is an EO material 6 that acts as a polarization rotator and a birefringent element (which is a material whose refractive index depend on direction of travel and/or polarization, i.e., an anisotropic material) 45, such that different angles of propagation result in different phase retardation of polarization. Another EO material 6 acts as shutter element that uses an electronic signal 27 that turns the light into a desired polarization so that only one of the round trips are allowed to exit the cavity, and the transmitted light has traveled a desired optical path or depth. This is a representation of a coaxial FEC with polarization clocks and segmented gated apertures with desired gating mechanisms. In some embodiments, each of these elements is segmented, such that light from different portions of a segmented display travel different distances.

46 is a display 1 followed by a micro-curtain 19 and a QWP 10 to function as pre-cavity optics. This allows desired profiling of the light of the display. The pre-cavity optics can adjust the polarization, angular distribution, or other properties of the light entering the cavity. 47 shows of a stack of elements: a display 1, a QWP 10, a micro-curtain layer 19, and an antireflection element 15. This subsystem is used in many disclosed systems and is categorized as a display. The micro curtain can be arbitrarily engineered, and it allows for control of the directionality of the light and the visibility of the display. The AR layer allows for reduction of ambient or internal reflections of the systems that use this subcomponent. In some embodiments, the AR element is a coating on substrate.

Subassembly 48 is a sub-assembly consisting of an AR element 15 and an absorptive polarizer 8 on one side facing a viewer and outside world, and a QWP 10 another optional AR element 15 or film on the side that faces the display from which light exits. In some embodiments, the AR element is a coating on substrate. In this disclosure, 48 is an example of aperture optics called an ambient light suppressor. In some embodiments, the ambient light suppressor is the final set of optical elements that the light experiences before exiting the display system. In some embodiments, the ambient light suppressor further comprises a directional film or angular profiling layer to produce angular profiling of the light exiting the system.

Subassembly 48 functionally mitigates the nonuniformity (waviness) observed in the virtual image and decreases the ambient light noise received by the user. Some part of the ambient light reflects directly from the shield layer, and some part of the ambient light enters the cavity and comes back. In some embodiments, it is an aperture optic to transmit light from the display system to the outside world. It can be a stack of layers laminated or deposited together such that the light that enters the cavity changes polarization and is absorbed by the stack of polymers. In some embodiments, depending on the polarization of the signal light or the image light, it is tilted or bent to further decrease the ambient light and internal reflections of an FEC. In some embodiments, it is composed of absorptive polarizers 8, QWPs 10, or arbitrary antireflection coatings 15. In some embodiments, it has an absorptive layer 12 to further decrease the ambient reflection because the ambient light passes twice through the shield layer. In some embodiments, subassembly 48 has a liquid crystal layer 21 or optically tunable layer such that the electric signal applied can be leveraged to choose the image depth that needs to exit the cavity. In some embodiments, there is a liquid crystal layer with oscillating polarization on the shield layer to provide both polarizations to the outside world.

Subassembly 49 is a subassembly of a display with micro curtain layer and an AR element 15 on top.

An example of an off-axis, or non-coaxial FEC 50 is a sub-assembly consisting of two mirrors 3 on the top and bottom, a display 1 at the back, and an angled PBS 7 with LC plate 21 in the middle such that an ON/OFF electronic signal to the LC can change the length that the light must travel before it exits the cavity. In some embodiments, a stack of such angled PBS-on-LC splitters such that the length of the light travel can be programmed or controlled in multiple steps. In some embodiments, the mirror is a QM to rotate the polarization of the light.

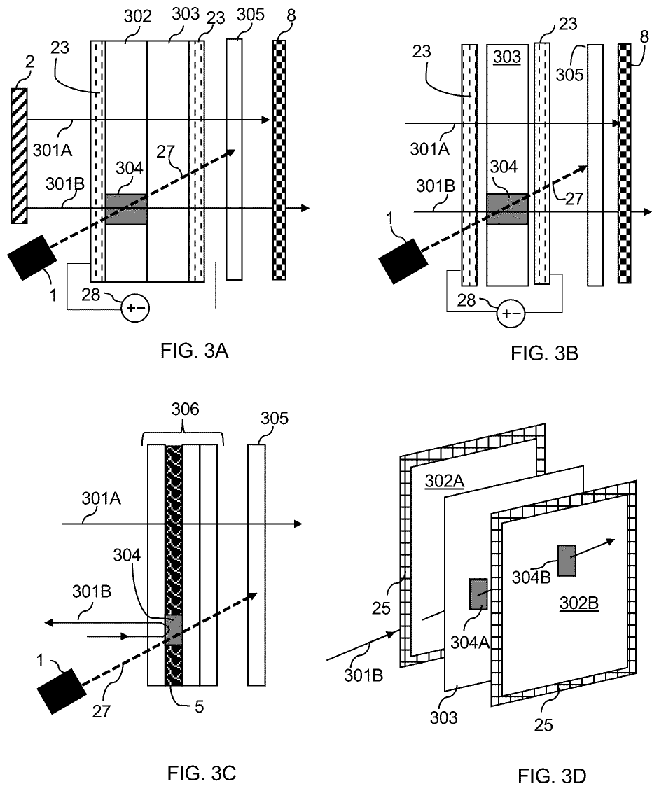

FIGS. 3A through 3D show the main embodiments of the disclosed invention. The different embodiments use a source to program or modify a material in a spatially nonuniform pattern such that image-forming light traveling through the system is itself modified according to that pattern. The programming mechanism may be electrical, acoustic, thermal, photovoltaic, photoconductive, optical, and the like. In some embodiments, the programming mechanism is cascaded with multiple events, each one causing a subsequent one in a chain. The invention here modulates light intensity, angle, polarization, coherence, frequency/wavelength (color). In some embodiments, this effects the image intensity, contrast, HDR, brightness, SNR, angular modulation effects.

FIG. 3A shows an embodiments in which multiple elements are layered. In some embodiments, there are spaces or gaps between the layers. In this embodiment, a voltage source 28 applies a voltage across a pair of transparent conductors, which have sandwiched between them a programming element 302 and a modulating element 303. In some embodiments, the programming element is photoresponsive, such that a write beam 27 from a light source 27 passes through the programming element and modifies an electrical property in an programming region 304.

For example, the modulating element may be an LC plate, and the programming element may be a photoconductor that absorbs the write beam and modifies its conductivity in the programming region. The modified conductivity in that region locally changes the voltage across the LC plate. The result is that a first image-forming light 301A passes through it with one polarization, and a second image-forming light 301B passes through the programming region 304 and the LC plate to obtain a different polarization. The image-forming light then passes through an absorptive polarizer 8 which modulates the intensity based on the polarization creating a spatially varying intensity. In some embodiments, the light source 1 is a laser beam scanner whose position is changed rapidly, e.g., faster than a frame rate of the display 2. The beam profile is smooth, so that the resulting modulation is smooth and free of diffractive artifacts. A filter 305 removes any stray light from the write beam.

In some embodiments, the programming element is a transparent photovoltaic material instead of photoconducting. In such an embodiment, the light is absorbed a small voltage difference are generated in the programming region 314, including possibly at the surfaces of the photovoltaic material. Those voltage differences similarly correspond to voltage changes across the LC plate as above.

In FIG. 3B, the light source 1 that sends the write beam 27 into the components produces an programming region 304 in the modulating element 302 itself, i.e., the modulating element also serves as the programming element. In some embodiments, this is achieved by doping a modulating-element substrate with programming-element materials. In some embodiments the programming region is caused by multiple cascading effects. In some embodiments, it is an intrinsic, e.g., nonlinear effect. In some embodiments it is a doped LC plate doped; in some embodiments it is a nonlinear, self-induced effect; in some embodiments it is something other than LC substrate. In those embodiments where the modulating element has electro-optic properties, such as LC plate or EO material, a voltage source 28 applies a voltage across two transparent conductors 23, and the modulating element 303 is sandwiched between them. A filter 305 and absorptive polarizer 8 remove any stray light from the system.

The embodiment in FIG. 3C harnesses surface effects, especially via thin films and multilayer films. For example, a multilayer element 306 is largely serves as an anti-reflection (AR) element to a first image-forming light 301A, which passes through it. One of the layers in the multilayer films is a phase change material (PCM) 5. When a light source 1 emits a write beam 27 into the PCM, its phase changes in the programming region 304, causing an index change. The result is that a second image-forming light ray 301B experiences a highly reflective element reducing the transmitted intensity there. A filter 305 removes stray light. In some embodiments, the light source is an infrared (IR) source. In some embodiments, the source is a non-electromagnetic thermal source.

In some embodiments, the layer material is not a PCM but some other responsive material that reacts to mechanical changes, electronic, environmental changes, optical changes, quantum changes, Casimir forces, and the like. The mechanism may be index-based or absorption-based. In some embodiments, one or more of the layers may further be electrically switchable.

Last, FIG. 3D is an embodiment in which the source of the modulation is a source array 25 that lies along the boundary of the system's elements. For example, an image forming light ray 302B passes through a first and second modulating element 302A, 302B and through a programming element 303. The source arrays 25 modulate the first and second modulating elements' interiors, and an programming region 304B is generated. In some embodiments the sensor array surrounds the programming element itself and generates its own programming region 304A. For example, the modulating elements may be transparent conductors, and the source array comprises independently controlled electrodes to produce a spatially varying voltage across the transparent conductor. Because the voltage satisfied a well-posed differential equation in the interior, it will be smooth and avoid diffractive artifacts. The programming element may be an LC plate to rotate the polarization accordingly of the light-forming light, and a final polarizer may serve to convert the polarization changes to intensity modulation.

In some embodiments, the differential equation is Laplace's equation. In some embodiments, it is the diffusion equation. The sources array creates well defined Dirichlet boundary conditions for this problem. In other embodiments, there may be gaps between the sources making it a mixed Neuman-Dirichlet problem, for which well-posedness must be assessed.

In some embodiments disclosed herein, the programming element is pixelated, but because the image-forming light is not impacted by the programming element, the image-forming light does not inherit diffractive effects.

Further, it should be noted that the light source 1, source array 25, or any non-optical source (thermal, electric, electronic, magnetic, mechanical, acoustic, and the like) that produced the pattern for the programming element is called a “secondary source.”

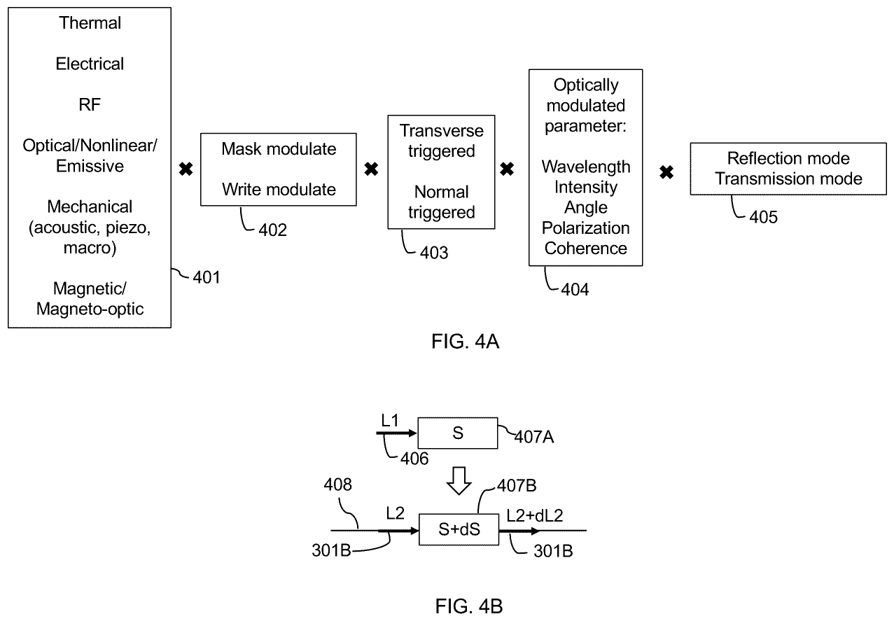

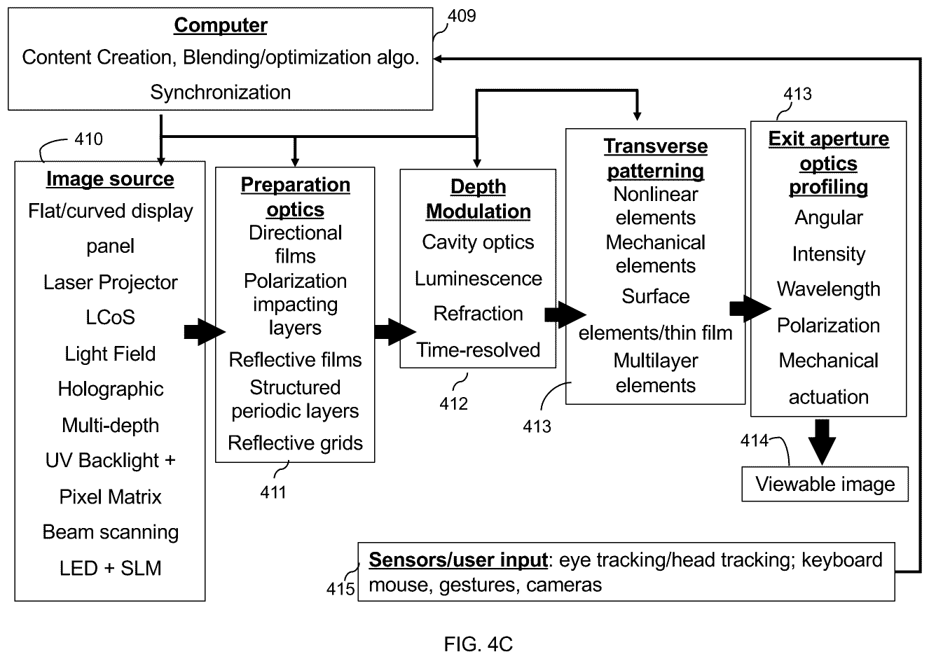

FIGS. 4A through 4C are a set of block diagrams depicting the functions of the apparatus. FIG. 4A is a “multiplication map” that summarizes some aspects of the different embodiments of the invention. The main structures of the apparatus are a coupling modality, a coupling method, a triggering method, an output property modification, and a geometric mode. The coupling mechanisms are shown in a coupling function block 401 and can include thermal, electrical, radio frequency (RF), optical, mechanical, magnetic, and the like. These are the methods to program a programming element. Each of these is a broad category in which several sub-mechanisms may be included. For example, electrical coupling may include de or ac voltages, de or ac currents, or any electronically controlled source. The thermal coupling includes thermoelectric effects, radiation and electromagnetic absorption, thermal source contact, and the like. The optical coupling means that the source that generates the pattern is optical, which may be visible, infrared (IR), ultraviolent (UV), and combinations thereof. In some embodiments, optical coupling is effected through a nonlinear effect, photorefractive effect, electro-optic effect, photoconductive or photovoltaic effects, photoluminescent effects, and the like. Mechanical coupling generates the mask using a mechanical source, such as piezoelectric actuation, acoustic sources, or mechanical actuation. Magnetic coupling includes immersion in a magnetic field, generation of magnetic fields through current sources, Zeeman effects, and the like. In some embodiments, the coupling mechanism may be considered as falling into multiple categories. For example, a photorefractive effect may be simultaneously considered as electrical and optical coupling. A magneto-optic, magnetic Kerr optical, magnetic circular dichroism effect may be simultaneously considered as magnetic and optical coupling. In some embodiments there are multiple, cascaded coupling events, whereby a first mechanism triggers a second mechanism, which itself triggers a third mechanism, etc., in order to form a pattern to imprint on the image-forming light.

The modulation method block 402 shows that the pattern may be generated by either modulating the programming or modulation element directly (e.g., by applying a source array around its edges) or by modulating the source itself (e.g., by mechanically scanning a laser beam across the modulation element). In some embodiments, both mechanisms are used.

The trigger method block 403 shows that the pattern can be formed by the coupling mechanisms interacting with the modulation element head-on, i.e., normally triggered, or approximately normally triggered. Alternatively, the triggering can be completed by exciting the modulation element from the edges, as is done in the source array in FIG. 3D.

The modulation element may imprint the pattern onto an arbitrary optical parameter of the image-forming light, as shown in the parameter block 404. The optical properties include wavelength (or frequency, or spectrum, equivalently), intensity, angle, polarization, and coherence. In some embodiments, the pattern is imprinted onto one of those properties and then interaction with subsequent optical components maps that pattern to a second optical property.

Last, the geometry block 405 shows that the pattern-imprinted image-forming light transmitted by the optical system or reflected by it. Example geometries are discussed below. In some embodiments, a multifocal display may have different image planes operate in different geometries. In some embodiments, the image-forming light is patterned and transmitted a plurality of times through the modulation element if it a reflected is disposed in the path.

FIG. 4B shows a high-level system diagram. The initial-state system 407A, S, has a source 406, L1, incident on it. That modifies the system in some way, changing it to a second-state system 407B, S+dS. In this state, the image-forming light 301B, L2, is modulated into L2+dL2. The modulation varies transverse to the optical axis 408.

FIG. 4C shows a block diagram of the system. The overall system may be considered in terms of several functional subsystems. A computer subsystem 409 is the electronic hardware and signaling that generates the image content; performs any blending, optimization, or correction algorithms; receives feedback from a user; and synchronizes the different subsystems. This subsystem includes the electrical hardware, communication channels and ports, and machine-readable storage devices, processors, and electronic signaling voltages and currents. This subsystem is coupled to others, including an image source subsystem 410, which lists possible methods to generate image-forming light. In many embodiments, the image source is a display panel, but there are other sources, including holographic sources, image projectors, multidepth displays, lightfield displays, source plus SLM or DMD, beam scanners, and the like. The light is profiled with the optics in the preparation optics block 411. This includes polarization preparation (e.g., wave plates and/or polarizers), angular profiling layers such as directional films, various gratings or diffractive structures, thin films, precavity optics, or other structured elements. The prepared light then is depth modulated using the tools in the depth modulation block 412. A field evolving cavity uses cavity optics to evolve the wavefront, but other methods are available, including luminescent methods, refractive methods, and time-resolved methods. In some embodiments, the depth modulation produces images such that the focal plane is curved. In embodiments for which the display is not a virtual display system, then the depth modulation block 412 is absent.

Next, the transverse patterning block 413 shows the different mechanisms for transversely modulating the image light. The physical mechanism were described in FIG. 4A. This block describes some of the structures that would be used, including surfaces, thin films, or multilayer elements; mechanical or clastic elements, nonlinear elements, and the like; various pump-probe-type configurations; natural diffusion or conduction effects; and the like. The embodiments of the present disclosure, for example, as shown in FIGS. 3A through 3D and FIGS. 5A through 9I, enable this block.

The patterned light then exits the system through components described in the exit aperture optics profiling block 413. These components are like those in the preparation optics. The result is a viewable image 414 for viewer consumption. In some embodiments, the viewer may input information through various sensors or inputs described the sensor/user input block 415 to control the image specifications or the content itself. The sensor/input information is fed back into the computer system. In some embodiments, the input may directly modulate the optics in the other blocks, without synchronization from the main computing system.

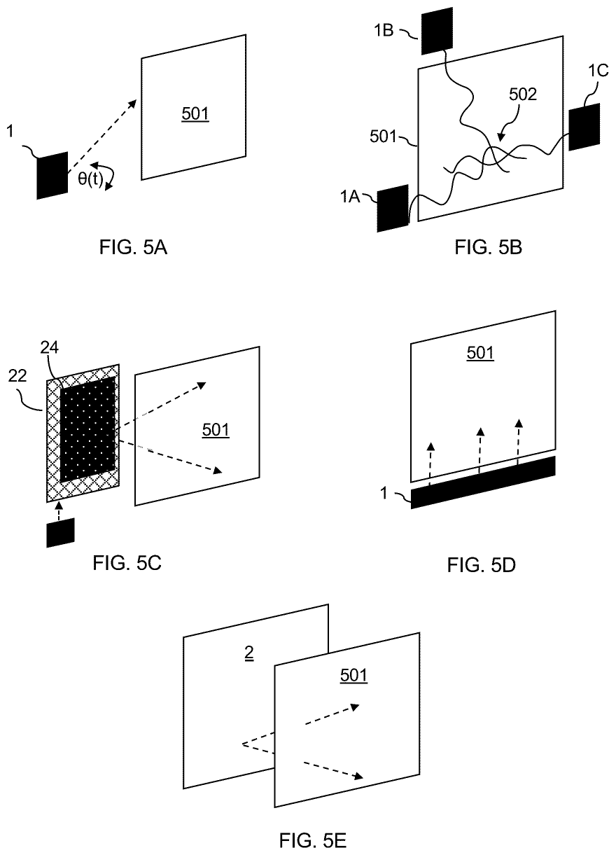

FIGS. 5A through 5E show various light delivery systems. The light delivery systems can be used for either the image-source generation, the mask modulation generation, or both, depending on the specific embodiments. FIG. 5A shows a light source 1 that is a laser beam scanner whose angle of incidence θ(t) on the optical component 501 varies with time. It is mechanically actuated. In some embodiments, it is the source of the pattern formation and raster scans or line scans across an image one or multiple times for each frame. In some embodiments the light source emits light into a collimating optic/lens group and passes through a spatial light modulator (SLM) or is reflected by a digital mirror device (DMD) or other digital light processing (DLP) tools. In some embodiments, the light source 1 is a projection system with a collimating lens or lenslet array. In some embodiments, the light source is a projection system with an angular profiling layer such as a diffusing screen.

FIG. 5B has multiple light sources 1A, 1B, and 1C distributed around the edges of the optical component 501. In some embodiments, these sources are coherent and produce an interference pattern 502. The optical component may be a nonlinear element to serve as the modulation element. For example, it may be a material that has a Kerr-type or saturable nonlinearity, whereby the local index is a function of the intensity. In other embodiments, the element is a diffusing plate, and the pattern scatters to a viewer.

FIG. 5C shows a light source 1 emitting light input a waveguide 22 which has a grating 24 on its surface. As the light propagates along the waveguide, it is directed transversely toward the location of the grating, at which point(s) it is scattered toward the optical element 501. In some embodiments, there are multiple light sources, waveguides, and gratings, each set optimized for a different spectrum/color. In some embodiments, the waveguide is replaced by a light pipe, light guide, fiber bundle, or periscope architecture. In some embodiments, the waveguide is reconfigurable. In some embodiments, as shown in FIG. 5D the light source 1 is an edge source that coupled light directly into the optical element 501.

In FIG. 5E, the light source is a display 2 that couples light into the optical element 501. In some embodiments, it is a standard display panel. In some embodiments, it is a UV backlight with an LCD matrix. In some embodiments it is a transparent display. In some embodiments, there is a gap between the display and the element.

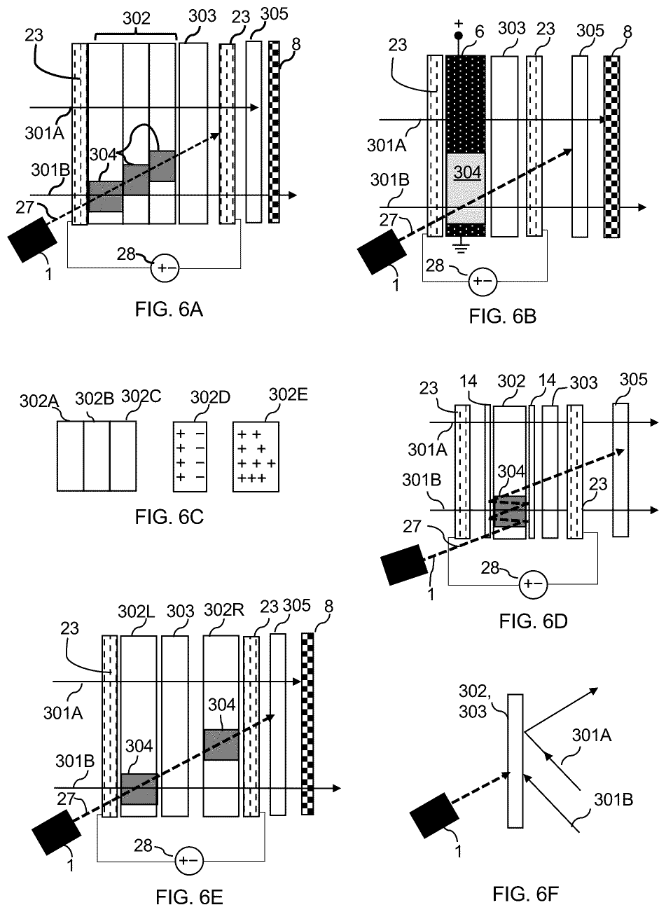

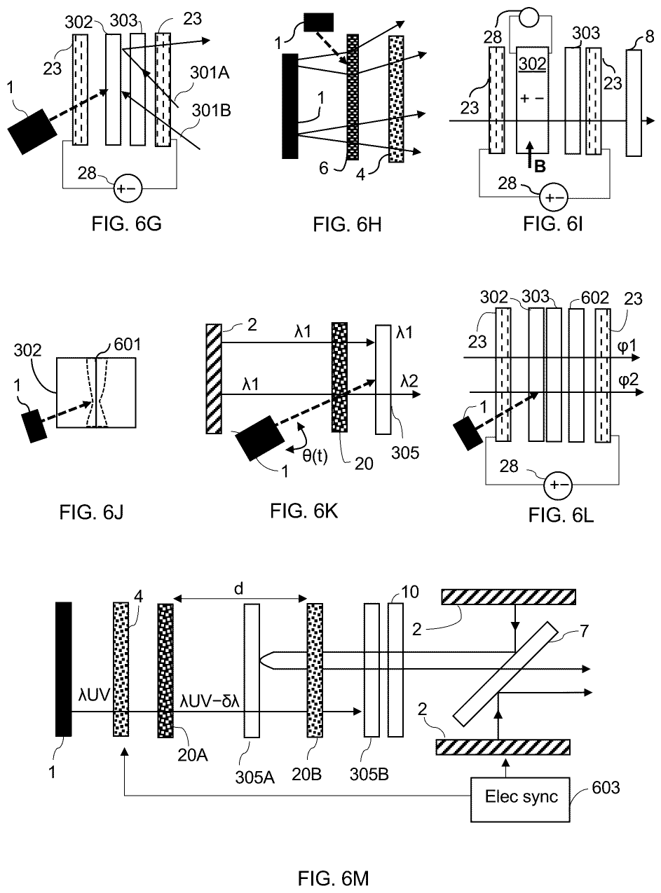

FIGS. 6A through 6M depict various embodiments similar to the multiple-element embodiment of FIG. 3A. In FIG. 6A, a light source emits a write beam 27 which activates a plurality of programming elements 302, each producing an programming region. Because of the directionality of the write beam, those programming regions occur at different spatial locations. In some embodiments, there are multiple light sources, and an array of programming regions produce a complex three-dimensional pattern. For programming elements that are photoresponsive, e.g., photoconductive and/or photovoltage, that three-dimensional pattern maps to electrical properties to spatially pattern the voltage across the modulating element 303. These elements may be biased between transparent conductors 23 with an applied voltage. If the modulating element is an LC slab or similar EO material, then the polarization will be rotated based on that spatial pattern, such that a first light ray 301A and a second light ray 301B experience different polarization changes. A filter 305 removes stray light, especially from the write beam 27, and an absorptive polarizer 8 converts the polarization modulation into a meshless intensity pattern. In the case of an LC plate modulation layer, the rotation angle change dA is calculated by the change in voltage: dA=dV/V, where V is the applied voltage without any programming.

In some embodiments, the transparent conductors 23 with applied voltage 28 are not necessary, and a space charge field develops in the programming elements 302 or in the modulating element 303 themselves. In some embodiments, the voltage is a high-frequency (e.g., MHz or GHz) signal, and the resonance and off-resonance properties of the AC circuit are used to impact the patterning.

In this disclosure the programming region 304 vary transversely across the programming and/or modulating elements, and this variation generates a pattern. The pattern is transferred to image-forming light in the modulating element. Thus, a pattern is generated when a secondary source (such as the light source 1 in FIG. 6A) produces a local programming region in the programming material.

In the embodiment in FIG. 6B, two transparent conductors 23 sandwich an EL material, which serves as the programming element, at a modulation element 303, which may be an LC plate in some embodiments. The system is biased with a voltage source 28. A light source 1 emits a write beam 27 that is absorbed by the EO plate 6 in a programming region 304. Because of the EO effect, the voltage is tuned slightly in that region, causing the LC plate to experience a voltage change there. A first light ray 301A and a second light ray 301B will thus experience different polarization modulation, which translate to an intensity pattern after propagation through an absorptive polarizer 8. A filter serves to filter stray light, including the write beam. In some embodiments, the EO plate is replaced by one or more transparent photovoltaic materials.

As shown in FIG. 6C, in some embodiments, there are multiple programming elements 302A, 302B, and 302C. In some embodiments, such programming elements induce voltages by inducing charge separation at their surfaces for surface-charged photoresponsive programming elements 302D. In some embodiments, a net charge is devolved through charge transfer in a charged photoresponsive programming elements 302E. Further, in some embodiments, a single element provides multiple functionalities (including the combined modulation and programming element of FIG. 6F, below). For example, a transparent conductor such as ITO has an absorption spectrum and absorbs infrared (IR) and ultraviolet (UV) light (in addition to some small amount in the visible). Other metallic films absorb light and may be thin enough to be partially transparent. Such materials in some embodiments act as the programming layer as a photoresponsive material and simultaneously as connected to a biasing voltage source. After absorption an applied electric field causes a space charge field to develop and therefore distort or modify the electric field near the modulation element. In some embodiments, the space charge field occurs at the interfaces between LC, EO, TO, PV, or other photoresponsive layers. In some embodiments, the material is GaAs or similar semiconductor.

Some embodiments use resonant effects to enhance the pattern's properties, such as dynamic range. For example, in FIG. 6D, transparent conductors 23 biased by a voltage source 28 sandwich a programming element 302, which may be photoresponsive, and a modulation element 303 which may be an LC slab or EO material. Further, the programming element is sandwiched between a smaller cavity comprising two semi-reflectors such as beam splitters 14. As the light source 1 emits a write beam 27 into this cavity, it is resonant, and effectively bounces back and forth multiple times within an programming region 304. Thus, if the programming is effected by absorption, then because light is absorbed with each pass, more light is absorbed overall than without the resonant cavity. More absorption translates to increased photoresponse such that a first light ray 301 and a second light ray 301B experience a significantly different patterning. A filter 305 removes stray light. Note that any cavity or resonant behavior can also be exited from the edge.

FIG. 6E shows an embodiment similar to that in FIG. 6A except that there are two programming elements 302L and 302R on the left and right slight of the modulating element 303. The ordering and number of the programming elements and modulation elements is arbitrarily engineered.

FIG. 6F shows an embodiment that operates in reflection mode: Image-forming light rays 301A, 301B are incident from the right and are reflected to the right. In this embodiment, the programming and modulating elements 302,303 are one in the same. A light source illuminates this element and is absorbed. The absorption modifies the band gap structure of the element, which is a semi-conductor. For, example, some embodiments rely on the Franz-Keldysh effect or other electro-absorption effects. In this embodiment, light that strikes the illuminated region experiences a different reflectivity than light that does not, i.e., the patterning modulates the reflectivity of the modulation element. A similar reflective mode geometry is shown in FIG. 6G, where the programming element 302 and the modulating element 303 are sandwiched between transparent electrodes 23 which are biased by a voltage source 28. The light source illuminates the programming element and changes its photoconductivity, which causes the modulation element voltage to vary. If the modulation element is an LC plate or EO material, the incident light will experience different polarization changes. Upon reflection in the system, either by the programming element itself, which may have a high reflectivity, or a reflective polarizer inside, the image-forming light experiences a double pass through the modulation layer to amplify the patterning. An absorptive polarizer may be used to transfer the polarization pattern to an intensity modulation. In some embodiments, the reflection is coaxial. In some embodiments it is off axis. In some embodiments the programming element is alpha-hydrogenated-silicon. In some embodiments, a thin-enough layer of a-H—Si does not affect the vis transparency too much. Color correction with display temperature can correct color variation.

In some embodiments, optical phase or path length is modulated. For example, in FIG. 6H, a large light source 1 serves as a backlight to a liquid crystal (LC) matrix 4. This is, for example, a standard LCD display, with the polarizer omitted for clarity. An EO material 6 which is photorefractive is programmed by a light source 1. In some embodiments there is a voltage applied to cause a drift nonlinearity. In some embodiments, the diffusion nonlinearity is used. The photorefractive effect causes a local change in index, which refracts the backlight locally. Therefore, different rays pass the LC matrix 4 at different positions causing variations in intensity and lighting. This is discussed further below. In some embodiments, the photorefractive material is a thin film.

The embodiment in FIG. 6I is a cascaded effect. A voltage source 28 is applied both to a pair of transparent conductors 23 and a programming element 302 sandwiched between them, next to a modulation element, which may be a LC plate. The voltage source on the programming element may instead by a current source injecting charge into it. An applied magnetic field curves the current paths of charge carriers in the programming element creating a space charge field, which can be patterned by modulating the current, having an array of current sources, or spatiotemporally varying the magnetic field. The voltage across the LC plate is modified spatially and a pattern is imprinted onto image-forming light. The intensity variations are evident after propagation through an absorptive polarizer.

In FIG. 6J, the programming element 302 is photoresponsive and is a pn semiconductor, the light source 1 is absorbed and produces a pattern by modifying the depletion region 601.

In some embodiments, color or wavelength variation is used to assist in patterning the image light. In FIG. 6K, for example, an embodiment emits image-forming light of wavelength λ1 from a display 2. The image forming light and that from a pump light source 1 are both incident on a fluorescent layer, which is a photoswitchable material. The presence of the pump light causes the photoswitchable layer to absorb the display light and emit light at a different wavelength 22 in that region. The light source 1 may be a laser beam scanner and sweep across the photoswitchable element in time t with an incident angle θ(t). A color filter 305 then removes either of the wavelength to leave a spatially patterned image. In some embodiments, there are multiple such subsystems stacked together to account for multiple wavelengths within white light sources. An example of a material is chiral azobenzene. In some embodiments, the absorption and re-emission is generated via the Stokes effect. In some embodiments, the materials' spectra are tailored to be vary narrowband (e.g., single color).

In some embodiments the photoswitchable material is replaced with a reversible photochromic material that is turned absorptive in the visible by UV radiation on the order of 10 s of milliseconds. In some embodiments, the photochromism is faster (sub ms) through doping with nanocrystals. In some embodiments, spirooxazines with siloxane polymers are used.

In FIG. 6L, a voltage source 28 is applied between two transparent conductors 23, which sandwich, respectively, a programming element such as a photoresponsive material, a modulation element such as an LC plate, and a birefringent material 602. Such a material is anisotropic and responds differently to light traveling at different angles and/or with different polarizations. As before, a light source 1 excites and programs a pattern into the programming element 302, which modifies the voltage across the modulation element transversely. Then, as image-forming light passes through it, its polarization is modulated by different amounts. Next, as the light passes through the birefringent element 602, the different polarization causes each ray to travel a different path length or phase difference, φ1 and φ2. In some embodiments, the light is coherent, and this modulates the phase which can lead to curving or refractive effects. Such an embodiment is effectively a freeform or locally collimating system. In some embodiments, this causes spatially varying blur or distortion. In some embodiments, there are multiple birefringent layers of varying orientation and material.

In FIG. 6M, a light source 1 emits UV light at a wavelength λUV. It passes through an LC matrix 4 to be patterned. This is the “write beam” (also called the secondary source) and generally is pixelated. Next, the light passes through a first fluorescent material 20A which shifts the spectrum only slightly to λUV−δλ. This light passes through a first reflective filter 305A, which is a notch filter and passes only this frequency, reflecting rest. Finally this light is absorbed by a second fluorescent material 30B, which is a photoswitchable layer. The presence or absence of the downshifted UV light causes the absorption or non-absorption of image-forming light, respectively. Because the first and second fluorescent layers are separated by a distance d, there is distance for the pump light to travel, diffract, spread out and blur to some degree. This effectively removes edge effects naturally to create a smooth pattern. In some embodiments, angular profilers or spatial filter further modify the pattern, which is mapped to the second fluorescent material 20B. Two displays 2 each carrying image-forming light are incident on a PBS 7. A bottom display is oriented to be reflected directly to a viewer creating a near image, whereas the top display is reflected, passes through the QWP 10, UV filter 305B (which removes any extraneous UV light), through the second fluorescent material 20B, where it is absorbed and reemitted at a different wavelength. That new wavelength makes a return trip through the system after reflection by the notch filter 305A. Because it makes a double pass through the QWP, its polarization is such that it is transmitted by the PBS 7 to the viewer for a far focal plane. In practice, the d is designed arbitrarily. An electrical synchronization 603 from a computer controls the content on the near layer display and the UV-incident LC matrix. In some embodiments, the display content on each are identical or nearly identical.

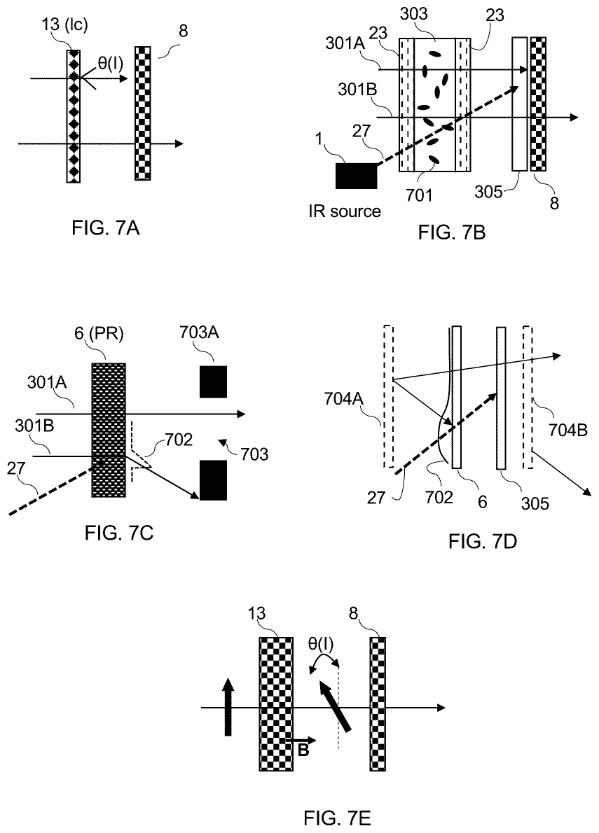

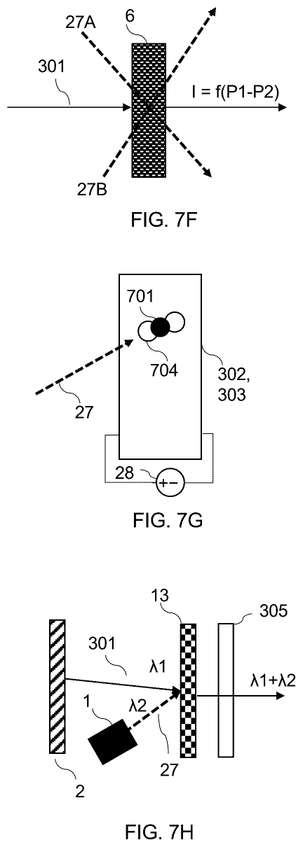

FIGS. 7A through 7I depict a set of embodiments in which the modulation and programming occur in the same material, as described in FIG. 3B. For example, FIG. 7A shows an embodiment in which an LC plate 13 serves as the programming and modulation element. Image forming light travels through it with a certain intensity at a certain direction. Because of the orientational nonlinearity of certain LCs, the angle of polarization angle is a function of local intensity: θ(I). Thus, if the incident light is itself nonuniform, the light afterward is polarization modulated based on that intensity nonuniformity, and passage through an absorptive polarizer 8 further modifies the pattern in a nonlinear way. The source light should be relatively close to the LC plate so as not to be completely blurred (effectively uniform). In some embodiments, the pump light of intensity I2 and image-forming light of intensity I1 are independent but coupled in the LC such that the polarization rotation is a function of both of them: θ(I1, I2). In some embodiments, the function is a function of their sum. In some embodiments, it is a function of the sum of their electric fields. Generally, any nonlinear effect may be useful: LC, photorefractive, thermal, electrooptic, orientational/density, plasmonic rectification, and the like. In some embodiments, the angle is described by coupled nonlinear equations.

In FIG. 7B, the Modulation layer 303 is an LC plate doped with particles 701. In this embodiment the particles are QDs. A voltage is applied across it because it is sandwiched between two transparent conductors 23. A light source 1, which is IR, shines a write beam 27 through the element, wherein the QDs locally absorb the light and the sample heats up. The resulting thermal expansion, changes in density or QD dispersal, and the like change the properties of the LC substrate such as the orientation, transition voltage, transition time and the like. Thus, a first and second light ray 301A and 301B experience different polarization modulations, such that after traveling through the absorptive polarizer 8 the intensity is patterned accordingly. A filter 305 filters out stray light. In some embodiments the applied field oscillates in time, and modulation is enhanced by varying transition times. In some embodiment, the LC is doped with other materials. In some embodiments, the dopants are photorefractive materials, dye, thermal doping (dyes that absorb, such that the LC directly absorbs light), resonant particles, graphene-doped LC, photoconductive LCs, CdS or PbS nanoparticles, and the like. In some embodiments, the host material is photorefractive with LC dopants. In some embodiment, there are multiple LC layers with different orientations and nonlinear strengths. In some embodiments, the LC is a polymer dispersed liquid crystal PDLC.

In FIG. 7C, the pattern forming is created by an EO material 6 that is photorefractive. A write beam 27 is incident on the photorefractive, which experiences a diffusion nonlinearity, whereby the index change is a function of the gradient of that intensity. If the write beam's intensity is I, then in one transverse dimension x, the index change Δn is Δn(I)=dI/dx. Thus, if the write beam is Gaussian shaped, the index change will locally be an approximate ramp, i.e., a small grating. A light ray 301A that does not pass through that portion will not be deflected and pass through the system aperture 703, which is determined by some iris 703A or other limiting stop. A light ray 301B that does pass through that region is then deflected according to the grating direction and is blocked. The result is a local dimming of certain regions.

An example of the implementation of this embodiments is shown in FIG. 7D. The EO elemental illuminated by a write beam 27 to created a refractive index pattern 702. Image forming light creates two virtual images, a near image 704B and a far image 704A. Part of the light forming the far layer is diverted (deleted, in this figure) so it isn't visible by the viewer. If there is front layer content at that location in that direction, then it will appear as if the front layer is properly occluding the rear layer.

In FIG. 7E, a nonlinear material 13 is has a magnetic field B applied to it. It is a nonlinear magneto-optic material sch that the polarization rotation is a function of intensity, similar to the embodiment in FIG. 7A. Typically, the effect is small, but it produces small polarization modulation effects that are transferred into an intensity pattern via an absorptive polarizer 8. In some embodiments, the material is colored crystalline quartz. In some embodiments, the magneto-optic material is a twisted Weyl semimetal, a metamaterial or metasurface, a magneto-electric material, yttrium iron garnet (YIG), bismuth-substituted YIG, terbium gallium garnet, other garnet substrate-based materials, magneto-optic thin films, and the like

In FIG. 7F, an EO material 6 is a photorefractive material such as lithium niobate, or manganese- or iron-doped lithium niobate or Bi12GeO20 or Bi12SiO20, has a first and second write beam 27A, 27B interacting inside it. The wave mixing coupled those beams to image forming light rays 301, such that the output intensity is the difference between the two pump beams I=f(P1−P2). This allows for effective “subtraction” or absorption of the image-forming light.

In FIG. 7G, a write beam 27 is incident on a modulation element 303 and programming element 303, which is formed by, e.g., a LC substrate doped with particles 701 that are nanoparticles resonant with the write beam. They generate a strong local electric field 704 to modulate the orientational properties of the LC locally.

In FIG. 7H, a light source 1 emits a write beam 27 of wavelength 22 into a nonlinear material 13, which also receives image-forming light rays 301 from a display 2 at a wavelength λ1. Due to frequency sum or difference generation, the output wavelength will be a linear combination, say λ1+λ2. A color filter 305 blocks out any stray light. By properly scanning and phase matching, a smooth pattern at this final frequency creates an image at that color. In some embodiments, this is intended for coherent light.

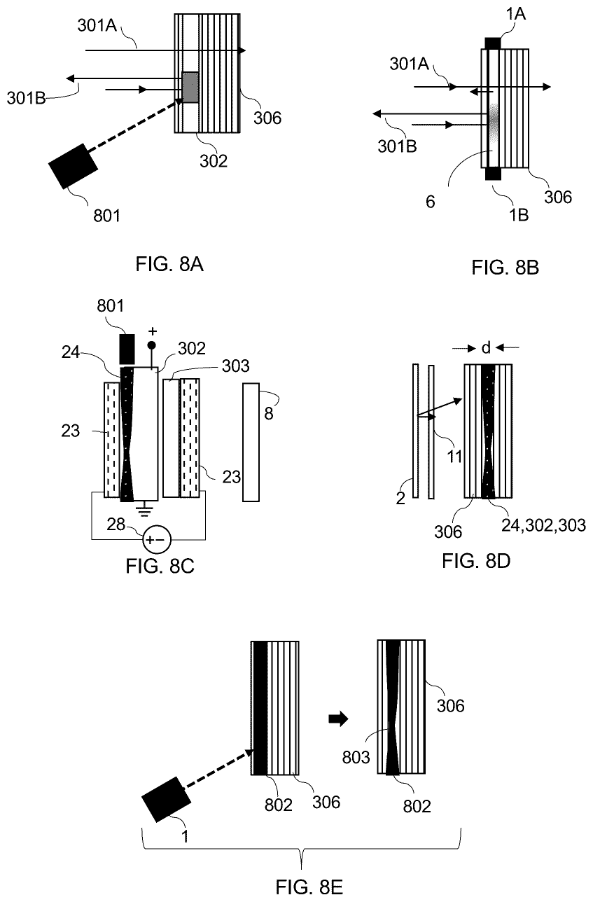

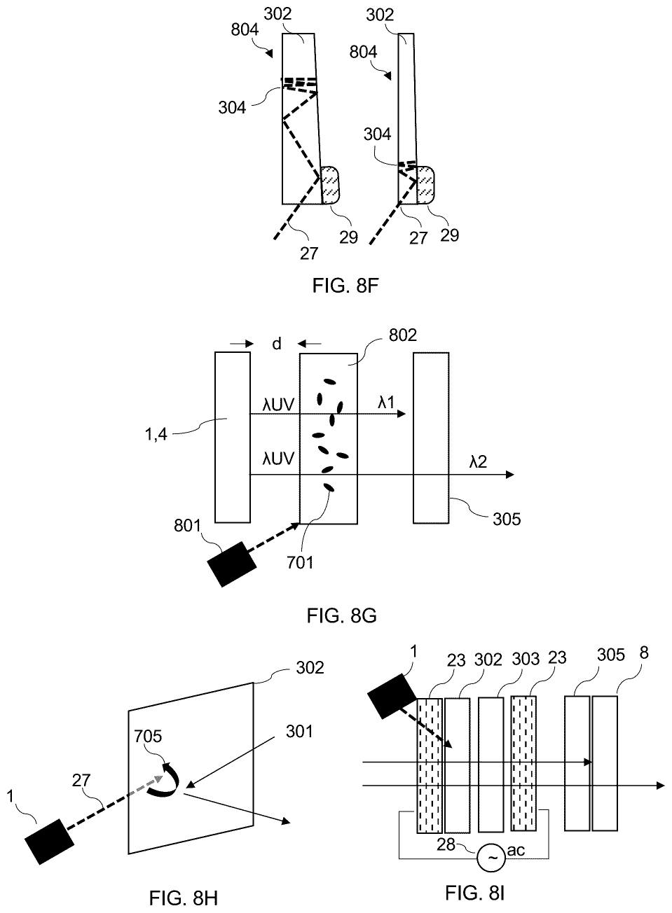

FIGS. 8A through 8I describe embodiments similar to that in FIG. 3C, whereby the modulation and patterning occurs via the interaction of thin films or surface effects. FIG. 8A shows an embodiment like that in FIG. 3C, but generalized. The multilayer stack 306 includes a modulation element 302 whose index changes when excited by a source 801 such that a first and second light ray 301A, 301B experience different cumulative effects of the stack, an anti-reflection coating in the former case, and a reflecting coating in the second case. The modulating element may be a PCM and the source an electromagnetic (including optical), radio, thermos-electric, or heat-inducing mechanical source), but it may also be an LC plate excited by optical or electronic sources, a nonlinear birefringent material, thin metallic layer with deeply subwavelength nanostructures that exhibit plasmonic resonances, and the like. In some embodiments, there are multiple such thin films arranged within the stack and multiple sources to excite them.

FIG. 8B shows a variation embodiment in which a plurality of light sources, including a first and second light source 1A and 1B, trigger a PCM 6 within a multilayer stack 306 from the sides. The result for coherent illumination, or a coherence length large enough relative to the film size to generate interference, is a superposition of waves. The result is a way of producing gradient index changes transversely (instead of using beam scanning or other complex patterning). In this way both light rays 301A and 301B experience some modulation, but their relative effect depends on their location relative to interference maxima.

In FIG. 8C, a source 801 is coupled into a grating 24 (or waveguide) or some other structured element that has elastic properties. In some embodiments the source is an acoustic source, and it excites mechanical deformations which cause it to expand or contract locally based on the source pattern. It is in contact with a programming element 302 such as a piezo-electric material with a voltage applied to it. The deformations induce stresses and strains on the surface of the piezo which in turn affect the voltage across the modulation element 303, which may be an LC plate. The components are biased by a voltage source 28 applied across transparent electrodes. When image-forming light rays pass through different regions of stress and strain they consequently experience different modulations through the modulation element, which may be converted into an intensity image by an absorptive polarizer 8, or in some embodiments a reflective polarizer

In some embodiments, as in FIG. 8D, the grating 24, programming element 203, and modulation element 303 are thin films in a multilayer stack 306. Image-forming light from a display 2 passes through an angular profiling layer 11 such as a directional film to tailor the ray directions. As the width d of the grating is modulated, the angular response becomes spatially varying. Effectively, this becomes a nonuniform distributed Bragg reflector. In some embodiments, the thin film thickness variation performs the entire modulation. In some embodiments, the excitation is acoustic, thermal, or electromagnetic; and other mechanical properties, such as temperature, density, or solution concentration causes a transverse patterning of the optical absorption properties.

In FIG. 8E, a multilayer stack 306 includes as a thin film a polymer 802 such as a hydrogel. In some embodiments, the hydrogels are spin coated. In some embodiments, the hydrogel is chiton. The light source 1 (or other type of source) is absorbed by or otherwise warms the hydrogel causing a change in relative humidity in a local space. That change in humidity subsequently causes the hydrogel to contract. The contraction 803 causes a change in the thickness of that film, which then changes the reflectivity and transmittivity at that location. In some embodiments, the hydrogel is part of a thin Fabry-Perot cavity, and the change in thickness tunes the resonance profile, for example. In some embodiments the hydrogel is doped with absorbing particles to assist with local heating effects

In FIG. 8F, a cavity 804 is edge-excited by a write beam 27. The cavity may be a FEC, but in some embodiments, it is a thin Fabry-Perot type cavity. The two semi-reflective surfaces are tilted relative to each other at a very small angle. As the light is reflected between the two surfaces its propagation direction gradually becomes more horizontal, until the round trips “accumulate” at a specific programming region 304. Inside the cavity might be a programming element 302, which is patterned strongly at that region. One surface of the cavity is coupled to a mechanical actuator 29, which can modulate the distance between them. At a smaller distance the accumulation programming region 304 changes. Thus, temporally modulating the mechanical actuator leads to strong pattern formation within the cavity 804 in the programming element 302.

In FIG. 8G, a polymer 802 such as a hydrogel has dispersed in it particles 701 such as fluorescent particles like QDs. A UV light source 1, and LC matrix 4 are separated by the hydrogel by a distance d to smooth out any artifacts by blurring. This light acts to excite the QDs which re-emit at a given frequency, depending on their geometry, band structure, and the like. A generic source 801 is absorbed by the hydrogel and its local relative humidity changes, causing it to contract and expand in a transversely nonuniform way. This changes the local dispersion of the QDs which in turn shifts their spectrum, causing the emission wavelength to be slightly different. In some embodiments, one or more filters 305 filter the wavelength to pass only the desired ones. In some embodiments, there are multiple such structures in parallel, or multiple QD species within the hydrogel to account for white light images.

In FIG. 8H, a thin photoresponsive sheet is a programming element 302 is illuminated by a spatially varying or scanning light source 1, whose write beam 27 generates a small local current 705. This could be created via photon drag or other photo-excitation methods. In some embodiments, the photovoltaic or photoelectric effect creates a space charge field that subsequently experiences current drift under a bias. In some embodiments, it is a cascaded effect whereby absorbed light creates a temperature change that induced a voltage (via, e.g., the photothermal or pyroelectric effect), which then results in local current flow. In some embodiments, the local absorption of light creates diffusion or currents from a consequent variation in doping, or the relative difference in diffusion of electrons and holes in a semiconductor. In some embodiments, an external field assists with the charge separation and current flow. In some embodiments, the programming element is electrically coupled to a modulation element to accept the charge carriers and have their inde3x change accordingly. This is the case for example, in free carrier index changes. The modulation element's reflectivity can therefore be impacted (via Fresnel equations) or it can be part of a multilayer stack.

In FIG. 8I, a voltage source 28 is an ac source applied to transparent conductors 23, which sandwich a programming element 302 and a modulating element 303. In some embodiments, a filter 305 and an absorptive polarizer 8 remove stary light. A light source illuminates the programming element, which is photoresponsive in some embodiments, and modulates the voltage across the modulation element, with is an LC plate in some embodiments. This is effectively a resonant circuit, with the transparent conductors acting as a capacitor. The ac source is tuned at resonance. Any change in the conductance causes strong deviation from resonance. In this way the modulation contrast is increased.

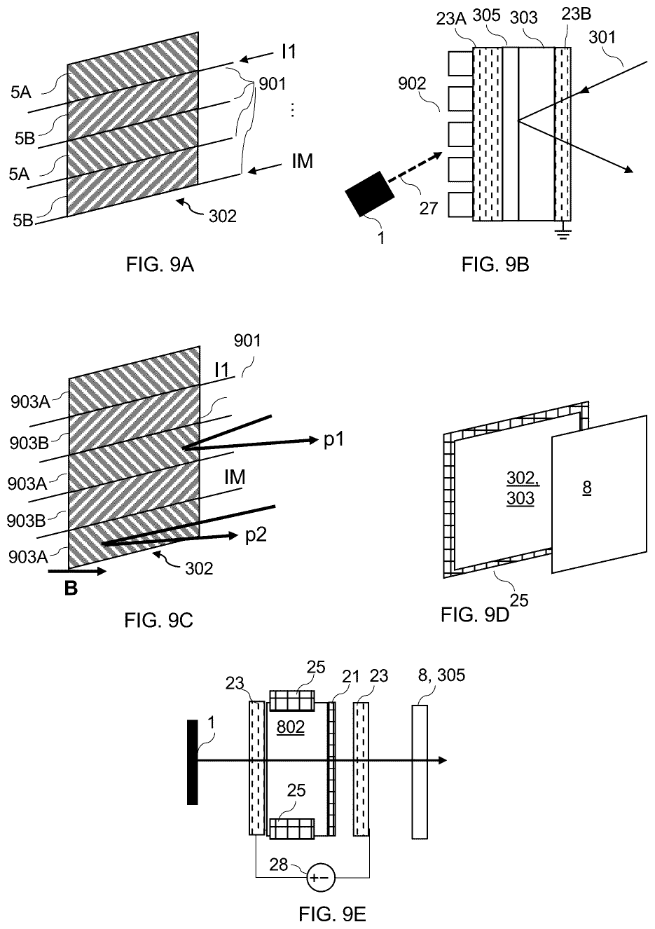

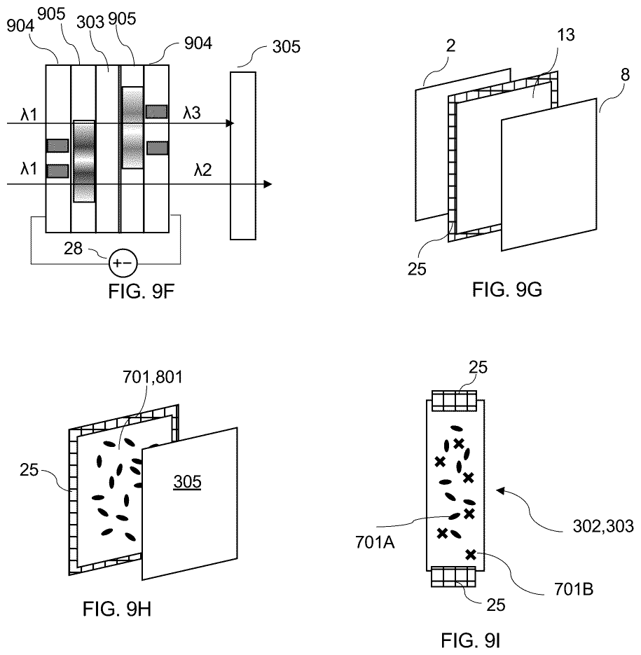

FIGS. 9A through 9I depict embodiments in which the sources of the modulation trigger the pattern from the edges of the various elements or from an array of sources, similar to that shown in FIG. 3D. In FIG. 9A, the programming element 302 is an alternating array of PCMs 5A, 5B. Although two are shown, the spacing, number of different materials, and pitch can be arbitrarily engineered. In some embodiments, they form a subwavelength grating. A current injection array 901 injects currents I1, . . . , IM into the PCM material, which is ohmic and generates heat. At the appropriate temperature(s) the PCM materials will change phase and therefore their index. Each current is independently controlled such that local phase changes can occur, creating a reconfigurable phase plate. For certain modes of light transport, it is a freeform mirror or lens. In some embodiments, the PCMs are thermally coupled such that thermal diffusion assists or impacts the smoothness of the pattern. In some embodiments, the physical smoothing is determined by other effects, such as particle diffusion.

In some embodiments, the mask is pixelated but physical separation, or diffusion (of any type) smooths out diffraction artifacts. This is effectively bulk engineering in absorption-light activated, acoustic, electron activated, magnetic activated, polarization activated, etc., materials. In FIG. 9B shows a light source 1 which is an IR display sending a write beam 27 into a pixelated IR sensor 902. This creates a pixelated mask pattern. The sensor is coupled to a thin transparent conductor such that the heat that is generated diffuses along the horizontal (according to the heat equation). In some embodiments, it is a different type of conductor, including one that is highly reflective to visible light. A filter 305 eliminates stray light, including IR stray light that was not absorbed. Incident image-forming light 301, shown here in reflection mode assuming a reflective conductor, passes through the modulating element 303. The modulating element is a PCM in some embodiments are another thermos-optic material whose index change responds to heat. In some embodiments, it is a QD dispersion, and the temperature affects its emission spectrum. In some embodiments, it is a thermally sensitive LC that rotates the polarization, and in this cause a second transparent conductor 23B is disposed after it to maintain a voltage ground. The light that is reflected is reflected in a transversely varying way based on the IR pattern and thermal diffusion.

The embodiment in FIG. 9C shows a modulation element 302 that is modulated by an injection current array. The materials are alternating first and second magneto-optic materials 903A, 903B, which may form a subwavelength grating. An applied magnetic field B causes incident light to be reflected with a polarization rotation, the polarization dependent on the field and the material properties. This is the reflective version of the Faraday effect, also called the magneto-optic Kerr effect. A first beam is reflected with a polarization p1 and a second beam p2, such that transmission through a polarizer will map this modulation to an intensity image. The spacing may be a subwavelength grating, and the current injection serves to locally program or modulate the magnetic field to create a transverse polarization modulation.

The embodiment in FIG. 9D is like that in FIG. 3D except that a single element, such as an LC plate, acts as the programming element 302 and the modulation element 302. A source array 25 surrounds the LC plate. The sources may be electrodes creating a voltage pattern. The LC is doped in some embodiments, such that the differential equation (or set of them) is richer than Laplace's equation, admitting local extrema, such that the polarization modulation can be engineered arbitrarily. Image-forming light that passes through it will experience a patterned polarization n modulation that is transferred to an intensity image using an absorptive polarizer.

The embodiment in FIG. 9E uses a polymer 25 such as a hydrogel coupled to a source array 25. It acts as a spacer between transparent electrodes 23 and an LC matrix. In, for example, an LCD display, the large backlight 1 is patterned by the LC matrix 21, which filters out light via a filter 8 and creates an intensity image with an absorptive polarizer 8. The source array 25 activates the polymer. For example, in some embodiments, it is a hydrogel using relative humidity changes, and subsequently the volume changes. As a result, the separation between the left transparent conductor and the LC plate changes in a nonuniform transverse way. Thus, there are stronger or weaker fringing fields that reach the LC matrix. Consequently, the polarization is modulated according to the pattern generated by the source array 25.

In some embodiments, the polymer is a thin film mechanical strains are used to adjust the polymer, which also include spiropyran-based polymers, microcapsule-embedded polyurethane films, chiral nematic LC elastomers, and polyvinylidene fluoride films.

The embodiment in FIG. 9F shows a thermo-electric (TEC) system where an array of transparent TEC sources (such as CuI) 904 are sandwiching one or more conductors 905 and a modulation element 303. In some embodiments, the modulation element is an array of QDs. The TEC arrays are controlled by a voltage source 28 (or a plurality of them) and create discrete temperature sources. The thermal contact with the conductors causes thermal diffusion according to the heat equation, such that the modulation element ultimately sees a smooth temperature profile. The band structure of the QDs is impacted and patterned by the temperature gradient, such that light rays of the same incident wavelength λ1 exit at different wavelengths λ2, λ3 based on the local emission spectrum, and a filter 305 will filter out unwanted colors creating an intensity image.

In FIG. 9G, a display 2 emitting image-forming light passes through a nonlinear material 13 and an absorptive polarizer 8. The nonlinear material is a liquid Kerr or otherwise isotropic Kerr material, which is responsive to the magnitude of the electric field. Some examples are nitrobenzene and anethole. The source array 25 is an electrode array that patterns the electric field within the Kerr material. Because it is response to the magnitude of the field and not the components, richer patterns can be afforded. The light experiences a locally varying polarization rotation that is converted to an intensity image after the polarizer.

FIG. 9H shows an elastic membrane such as stretchable polymer 802 with particles 701 such as luminescent particles (e.g., QDs) embedded in it. The source array is an array of mechanical actuators of acoustic sources sending acoustic waves into the membrane. As the waves are generated on the surface, the elasticity produces stresses and strains, which affect the spectrum of the QD locally. Thus, the QD membrane because a spatially varying emitter of light. Image-forming light that is absorbed is re-emitted in a patterned spectrum, which can be filtered with a filter 305. In some embodiments, the QDs are arranged in a MQW structure, and the strains adjust the geometry of the MQWs. In some embodiments, the QD are bound to exciton localizing ligands through a chemical reaction which change states of the QD-ligand system to tune the bandgap dynamically.

In the embodiment in FIG. 9I, one element serves as the programming element 302 and the modulating element 303. This element contains a dispersal of a first set of particles 701A, such as luminescent particles (e.g., QDs), and a second set of particles 701B, such as resonant nanoparticles. The source array 25 is a light source array or laser array that is resonant with the nanoparticles. The nanoparticles themselves generate strong local electric fields which are locally experienced by the QDs. In some embodiments, the QD temperature or density changes. In some embodiments, the quantum controlled or plasmon enhanced Stark effect shifts their bandgap. The result is a spatially varying emission structure.

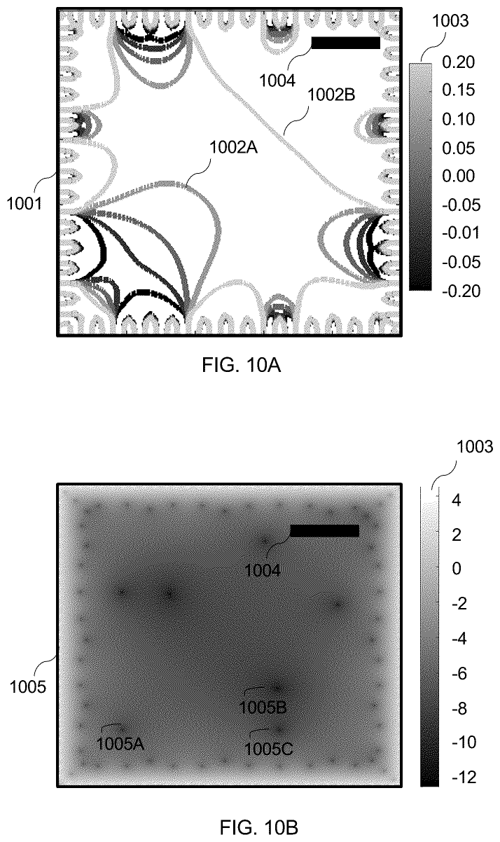

FIGS. 10A and 10B analyze an edge-triggered embodiment. To frame an example, the potential V in a 2D conducting square plate satisfies Laplace's equation:

$${∇}^{2} V = 0 , \qquad Eq . 1$$

subject to Dirichlet, Neumann, or mixed boundary conditions. In a Dirichlet problem, the interior of the conductor is determined by the values of the potential along the boundary. If the edge length of the plate is L, and each edge is populated with an electrode of length l, then there are N=L/l electrodes per edge, and 4N electrodes in total. The potential in the interior is then completely determined by the 4N potential values. The objective is to specify the desired voltage landscape Vₚ in the interior (corresponding to a desired pattern) and determine the set of values that most closely approximates it.

$$\{ {v}_{n}^{*} \} = arg min \{ {v}_{n} \} ‖ V - {V}_{p} ‖ , \qquad Eq . 2$$

Where vₙ are the 4N potential value parameters, and {vₙ*} are the optimized values. Here ∥ . . . ∥ represents an arbitrary norm. In some embodiments, it is an l-2, l-1, or l-m norm for arbitrary positive integer m. Any optimization procedure may be used, such as gradient descent. Now, a realizable potential is constrained by not taking on any local extrema in the interior (a mathematical property of Laplace's equation), similarly for the electric field components. However, the magnitude of the electric field may take on local extrema in the interior (for example, at a location where the x-component is decreasing, and the y-component is increasing). In some embodiments, the number N of electrodes may also be optimized. Physically, the size is limited by fabrication methods. The electrodes may also vary along each edge.

In some embodiments, Neumann or mixed boundary conditions are used. For a conductor, if the boundary is not held at a certain potential, the electric field must be perpendicular there.

FIG. 10A shows a contour plot 1001 of the voltage of the system described with 4N electrodes held at alternating potentials. Various equipotential curves 1002A and 1002B are shown, with their voltage correspondence indicated by the colorbar 1003 and the size of the plate indicated by the scale bar 1004, where the scale length corresponds to the length of 100 equi-sized electrodes.

FIG. 10B shows a log-scale 2D plot of the electric field magnitude, which its scalebar 1004 and colorbar 1003 indicating spatial and field values, respectively. Note that there are multiple local minima 1006C, 1006B, and 1006C in the interior of the conductor. An isotropic electro-optic material, such as a liquid, e.g., nitrobenzene or anethole, would respond accordingly. Their effect would take on local extrema, which corresponds to bright and dark spots in the desired pattern and resulting image.

In some embodiments, the physical equation to solve is something other than Laplace's equation. In some embodiments, it is the heat equation (for thermal sources). In some embodiments, it is the wave equation (for various acoustic, optical, or RF wave sources).

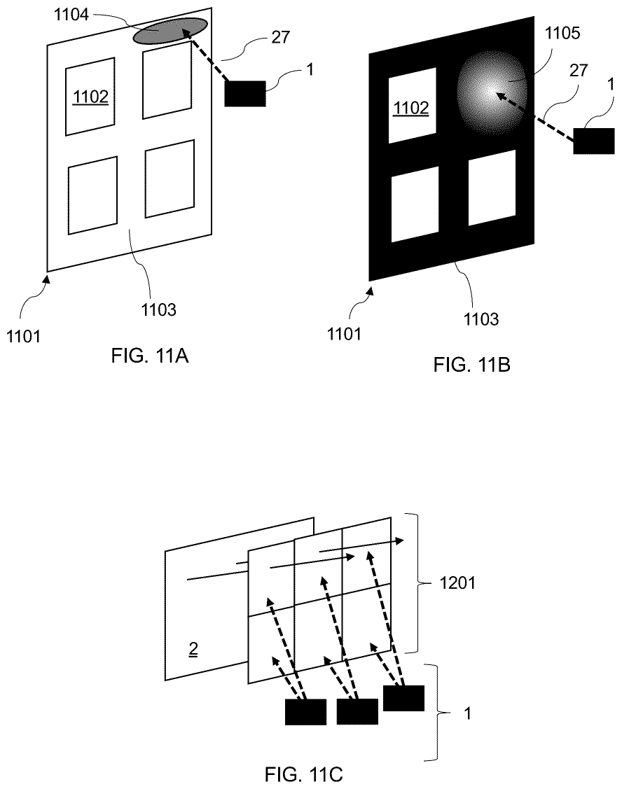

FIGS. 11A through 11C depict auxiliary methods of generating diffraction-free or diffraction-reduced transverse modulation. These involve using high-frequency or low-frequency patterns.

In FIG. 11A, pixelated optical element 1101, e.g., an LC matrix, contains pixels 1102 and interstitial regions 1103. The pixel pitch is on the order of microns, such that it generates unwanted diffractive artifacts. The index in the pixels take on one value, say n₁, and the index in the interstitial region takes on a second value n₂, such that the element acts as a phase grating, which has an approximate diffraction efficiency for the m^{th} order is (sin (mπΔφ/λ)/mπ)², where Δφ=2πd(n₂−n₁)/λ. In this embodiment, a light source 1 emits a write beam that is incident on the interstitial region in a localized spot 1104. If the element is made of electro-optic or other nonlinear material, then the interstitial regions index will change from n₂ to n₂+Δn. If this index change brings the interstitial index closer to the pixel index, then the diffraction efficiency will reduce in that location, and diffractive artifacts reduced. Thus overall, the diffraction is reduced, and further, if the light source scans or others introduces a transversely varying pattern, the intensity throughput is modulated accordingly. In some embodiments, a high frequency pattern illuminates the entire interstitial region.

FIG. 11B shows a similar embodiment, in which the pixelated optical 1101 has pixels 1102, and the interstitial region 1103 is completely dark. In this embodiment, the light source 1 emits a write beam 27 into the pixel itself, but the pixel is covered with a photoresponsive material that changes absorption based on the light. If the write beam, is say a Gaussian, then the pixel transmittance will vary as Gaussian beam. This is effectively per pixel apodization, which reduces higher-order diffractive effects. It doesn't eliminate the fundamental grating, but only higher order ones to the extent of the apodization.

FIGS. 11A and 11B show examples of introducing high-frequency modulation to effectively cancel out the diffractive artifacts. In some embodiments, low resolution masks provide useful effects, and because the resolution is low, extraneous effects are not introduced. For example, in FIG. 11C a display 2 emits image light through an array of meshless optics 1201 that are in turn excited by a plurality of light sources 1 (or other non-optical sources in some embodiments, such as electrodes). The display is effectively segmented into an array of patches, each patch having its own modulation. It should be noted that in FIG. 11C, even though the meshless optics 1201 are segmented, because the segmentation is far larger than the optical wavelength, diffractive artifacts are not introduced.

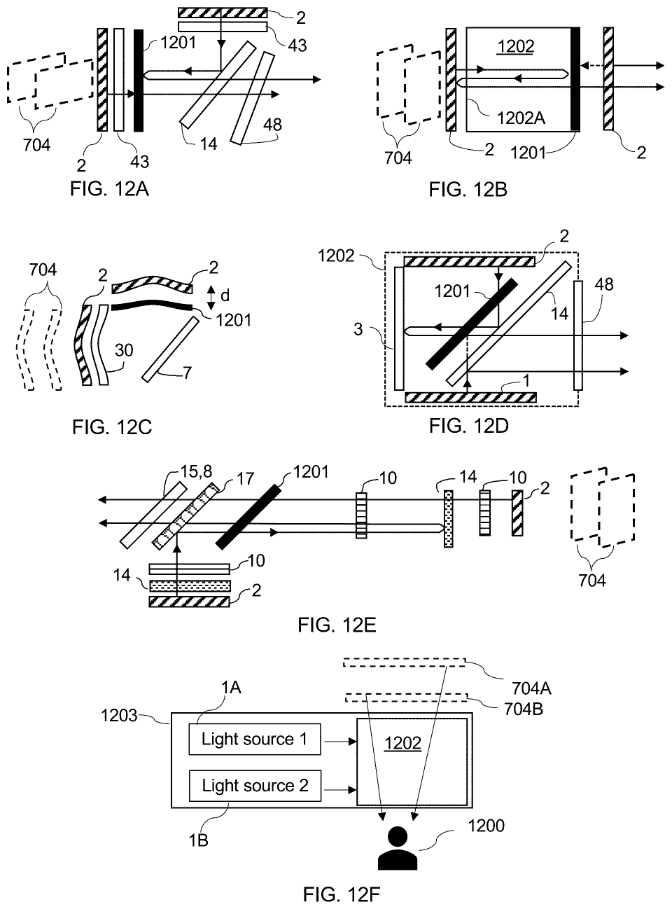

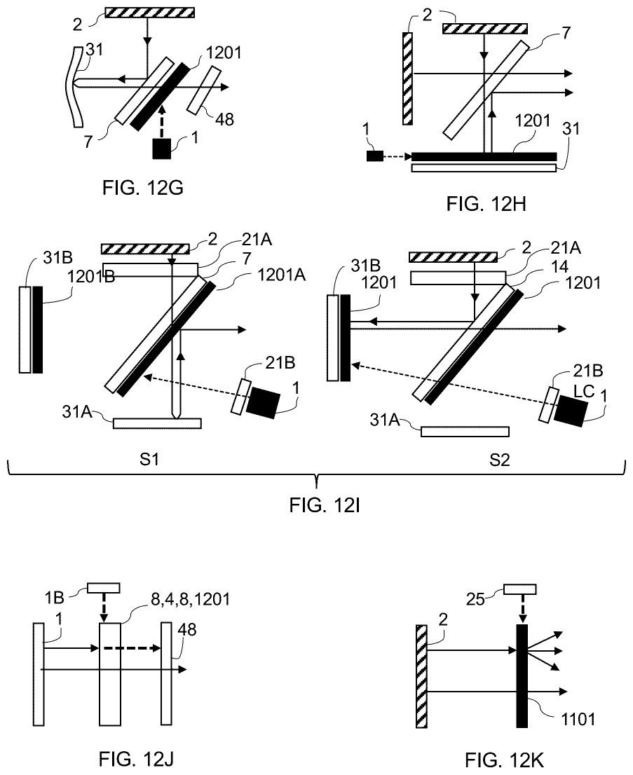

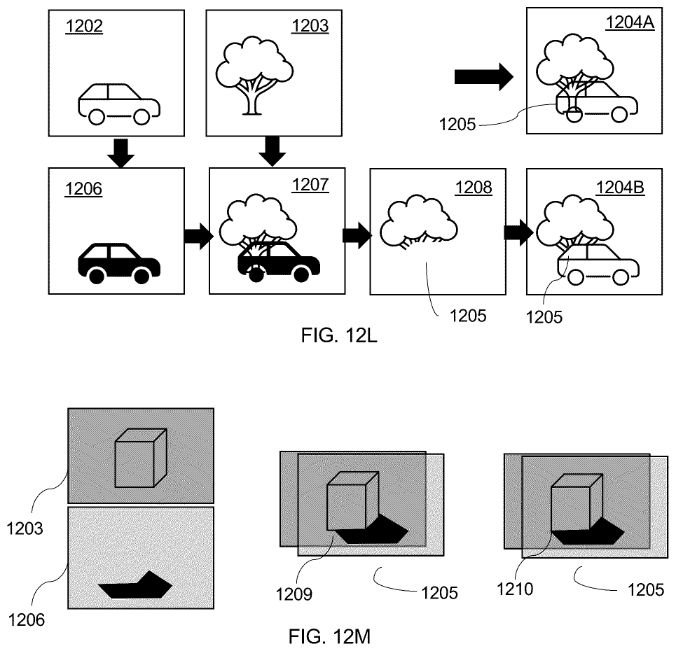

FIGS. 12A through 12M depict various geometries to implement the modulation subsystem in various display systems.

FIG. 12A shows a multifocal display system with two displays 2 each emitting image-forming light. The light from both displays passes through a respective pre-cavity optics element 43. The side display transmits light through the meshless optic 1201 that imprints patterns in reflection mode, then through a beam splitter 14, and finally exits the system through an aperture optic 48. The light from the other display first reflects light from the beam splitter 14 and then is reflected by the meshless optic 1201, which imprints a pattern onto that light. The light is then transmitted through the beam splitter 14 and through the aperture optic 48. The meshless optic serves to imprint a pattern on the light it reflects, which corresponds to the farther focal plane, whereas the light transmitted through it is a nearer focal plane. Note that if the spacing between the meshless optic 1201 and the side display 2 is minimal, the pattern imprinting onto the far focal content is effectively acting at the same depth as the near focal content. In some embodiments, the meshless optic absorbs both frequencies, but it is thin enough to ignore the loss in the signal light or compensate it with color variation. Virtual images 704 are visible.

The pattern that a meshless mask imprints on the far layer may be synchronized with the content of the near layer to mimic occlusions by near content of far content. This is described in FIG. 12L.

The size of the image depends at least in part on the size of the programming element, the modulation element, and the size of the source of the image-forming light. For larger-fabricated components, for example, the size may be between 1 mm and 5 cm, 5 cm and 20 cm, greater than at least 10 cm, between 1 mm and 41 cm, or between 25 mm and 450 mm. (All ranges inclusive of the boundaries.)

FIG. 12B shows a field evolving cavity 1202 that has a coaxial geometry. One display 2 emits light rightward into the field evolving cavity through a first partially transmitting surface 1202A, is reflected by the meshless optic 1201 to make a return trip, the is reflected by the first partially transmitting surface, and is transmitted through the meshless optic which then imprints a pattern onto the light. Subsequently, the light passes through a transparent display 2, which emits its own content, to produce an image for the viewer. In some embodiments, the transparent display and the first display produce a multifocal image. In some embodiments the transparent display serves to activate the meshless optic by emitting light to the left as well as to the right. Virtual images 704 are visible.

The embodiment in FIG. 12C is similar to that in FIG. 12A. Light from the top display 2 passes through a meshless optic 1201, which is physically separated by a distance d in some embodiments. The light, which is arranged to be linearly polarized in a certain direction is reflected by the polarization-dependent beam splitter (PBS) 7, is reflected by the QBQ 30 such that its polarization is rotated 90 degrees and is then transmitted by the same PBS to the outside world. The light traveling this path corresponds to a deeper virtual image that is patterned by the meshless optic. The other display 2 emits light through the QBQ 30 and then through the PBS 7. In some embodiments, the display panels are curved. In some embodiments, the QBQ and/or meshless optic are curved. Other pre-cavity optics may also be present and by curved. In some embodiments, such elements are coated onto the display panels themselves. The curvature of the components serves to magnify or minify the image, modify the headbox space, and change the monocular depth of the virtual images. Virtual images 704 are visible and have curved focal planes.

In FIG. 12D, an FEC 1202 houses a display 2 that generates image forming light and a second display that simultaneously serves as a light source 1 as well as producing image light. The light source emits light which is partially reflected by the beam splitter 14 and transmitted through an aperture optic 48 to form an image in the outside world. Some of the light leaks through the beam splitter and activates a meshless optic 1201, which imprints a pattern onto image forming light emitted from the top display 2. That light makes three passes through the meshless mask as it makes a round trip between the beam splitter 14 and the mirror. In some embodiments the beam splitter and the mirror are replaced by a PBS or reflective polarizer and a QM, respectively. This embodiment highlights how the meshless optic may be programmed using stray light from an image-forming light source.

FIG. 12E shows an embodiment with another geometry of a meshless optic. This embodiment produces multiple virtual images 704 and is thus a multifocal display producing a multifocal image. Light from a side display 2 emits light leftward into the system through a QWP 10, a beam splitter 14, and another QWP 10 (or alternatively a single QBQ), which serves to rotate the initial polarization by 90 degrees. The light then passes through a meshless optic, is aligned with and passes through a reflective polarizer 17 and through an aperture optic comprising an AR element 15 and an absorptive polarizer. In some embodiments the meshless optic is a nonlinear element that is modulated by this light, but this light does not experience that modulation. (For example, it may be a photorefractive-based material.) A bottom display 2 emits light upward with its polarized arranged to be reflected by the reflective polarizer 17 and transmitted through the meshless optic 1201 a first time with that polarization. Because its polarization is perpendicular to the first image, it has imprinted on it the modulation pattern. It is reflected makes a double pass through the QWP 10 by reflection from the beam splitter 14, is then transmitted by the meshless optic 1201, reflective polarizer 17, and the AR element 15/absorptive polarizer 8 aperture optic.

In some embodiments, the meshless optic 1201 comprises and EO material or one of the EO subassemblies in FIG. 2A or 2B. For example, it may be an EO reflector. In some embodiments, such an EO-based meshless optic is patterned by a secondary source comprising a set of electrodes. In some embodiments, the meshless optic 1201 is disposed on a surface of one of the semi-reflectors (e.g., the reflective polarizer 17, one of the beam splitters 14, etc.) or on a surface of one of the displays 1 or one of the other components. In some embodiments, the patterning set of electrodes has a characteristic scale this is much larger than a wavelength so as not to introduce diffractive artifacts. The scale may be, for example, 100 to 1000 times, 1000 to 5000 times, 1000 to 10,000 times, for greater than 5000 times the average wavelength of the light (taken to be approximately 0.5 to 1.0 um) or times the wavelength of any spectral component of the light.

FIG. 12F summarizes some aspects of the embodiments. The display system 1203 has a first light source 1A and a second light source 1B, either or both of which may emit image-forming light and/or pattern modulating light. They enter an FEC 1202 to produce virtual images 704A, 704B visible to a viewer 1200 as a multifocal image.

FIG. 12G shows an embodiment in which a light source 1 modulates a meshless optic 1201. Polarized light from a display 2 is emitted down toward a PBS 7, is reflected and rotated in polarization by a QM 31, and passes through the PBS 7. Now it passes through the meshless optic 1201 to acquire a pattern imprinting and exits the system through an aperture optic 48. Similarly, as shown in FIG. 12H, light from a top display 2 is polarized such that it passes through a PBS 7. It is reflected and rotated in polarization by the combination QM 31 and meshless optic 1201, which itself is programmed by a light source 1. In some embodiments, the programming is executed by any of the other mechanisms outlined above. The polarization-rotated light is then reflected by the PBS 7 and exits the system. At the same time, another display 2 may emit image-forming light such that it passes directly through the PBS 7. In such embodiments, the meshless optic 1201 and PBS 7 may jointly produce intensity patterning. For example, in some embodiments, the meshless optic is the combination of photoresponsive material plus LC plate sandwiched between transparent conductors. The polarization is patterned according to the mask, and the PBS 7 will reflect the light accordingly to reflect a spatially varying patterned image.

In the embodiment in FIG. 12I, a switching element is introduced. In a first state S1, light from a display 2 passes through a first LC plate 21A that is activated such that the transmitted polarized aligned with the axis of the PBS 7 and passes through it, then through the first meshless optic 1201A. It is reflected and rotated in polarization by a first QM 31A, then reflected by the PBS/meshless optic toward the outside world. The first meshless optic is patterned by light from a light source 1 that itself passes through a second LC plate 21B which is activated to polarize the write beam for absorption at that location

In a second system state S2, light from the display 2 is passed through an LC plate 21A that is activated such that the transmitted polarization is reflected by a PBS 7 and reflected by a combination second meshless optic 1201B and a second QM 31B. The meshless optic patterns the light according to a light source 1 which passes through a second LC plate 21B, which is activated to change the polarization of the write beam such that it is transparent to the first meshless optic and PBS and is absorbed by and patterns the second meshless optic 1201B.

In FIG. 12J, the embodiment is a regular display system, i.e., one that does not produce virtual depths. A display 2 emits light through an absorptive polarizer 8, LC matrix 4, absorptive polarizer, which also functions as a meshless optic 1201, which is simultaneously patterned by a secondary light source 1B, which is infrared (IR) in some embodiments The nonlinear interaction between the local intensity variation of the meshless optic 1201 and the IR light provides improves contrast through positive feedback effects (e.g., instabilities, or phase-matched nonlinearities). In some embodiments, the light exits through an aperture optic 48. Similarly, in FIG. 12K, a display 2 emits light through a meshless optic 1201 patterned by a source array. In some embodiments, the meshless mask controls a coherence or scattering property to make the light more or less diffusive. This creates extra lighting effects, perceptions of matte-ness, and the like. The meshless optic in these two figures allow for incorporation into existing display technology, such as LCD, OLED, micro-LED, LED, and the like. In some embodiments, the meshless mask is used in a TV improve contrast. In some embodiments, it is used in other conventional display systems such as laptops, tablets, smart phones, smart watches, in-vehicle displays, and the like. In some embodiments, the meshless optic creates local scattering by electrically or thermally controlling vibrations, wrinkling materials, phase change materials, EO-based switchable glass, and the like. In some embodiments, a source array of coherent sources creates speckle effects.

In some embodiments, the meshless absorber is layered on a mirror with a brightness enhancing film that either polarization recycles light to extract more light or to angularly profile the light and scatter it into a narrower viewing cone.

FIGS. 12L and 12M highlight the image results of the implementation of the disclosed embodiments. In FIG. 12L, the meshless optic serves to enhance occlusion effects in multifocal systems. In some embodiments, a multifocal image is created by presenting a near image 1202 and a far image 1202 at different focal planes simultaneously for a viewer. The viewer uses his accommodation depth cue to focus on the desired content. In typical implementations, the display content is additive: the light from the rear content adds to that of the front content to creating an overlapping image 1204A. This detracts from the immersion because opaque content on the front layer should occlude the content from the rear layer in that occlusion region 1205. But in the typical configuration, both sets of image-forming light add together to give the viewer a distorted scene. In some embodiments, a meshless optic has programmed into it a pattern 1206 that replicates, or approximately replicates the near content. The mask and the rear content combine via multiplicate 1207 to create an updated rear content image 1208. When the updated content is viewed with the front content, an updated multifocal image 1204B is seen and the mask successfully eliminates the contaminating rear-image light from the occlusion region. In some embodiments, the mask is an absorptive, refractive, spectral, or polarizing mask. In some embodiments, the front content is not fully opaque, but only partially, such that the meshless mask pattern only dims a part of the rear content.

The pattern may be further impacted by other factors such as user input, user profiles or settings, user history, and the like. The pattern may be based on a display content on a current focal plane or on the image content which it modifies in a subsequent frame. In some embodiments, an artificial intelligence (AI) generative module operates on a base pattern to generate a new pattern in accordance with an associated neural network or other AI-based model. In some embodiments other computer vision or image processing operations act on a base pattern to produce the final pattern to be imprinted.

FIG. 12M shows examples of enhanced content in which the meshless optic is meant to enhance brightness or lighting effects. A far content 1203, in either a multifocal display or even a normal display (where the two would be shown at the same depth). The meshless optic is used to enhance immersive or 3D effects by modifying shadows through absorption of light. The meshless optic creates a mask 1206 that absorbs any stray light right in a region. When combined, the complete image 1205 appears to have a stronger shadow, and the position of the shadow is optimized by analyzing the base image. If the shadow position cases an offset junction 1209, the result would provide a different effect than a flush junction 1210. In the first case, the object would appear to be floating more in the air compared to the second one. In some embodiments, other methods are used to enhance or modify alpha blending techniques to mimic shadows or other colors. In some embodiments, the original content is fed into an AI-generative network, such as a diffusion model or an autoregressive model, to generate those effects. In some embodiments in which the meshless optic affects the phase, various specular effects or ray-bending effects or blurring effects are induced.

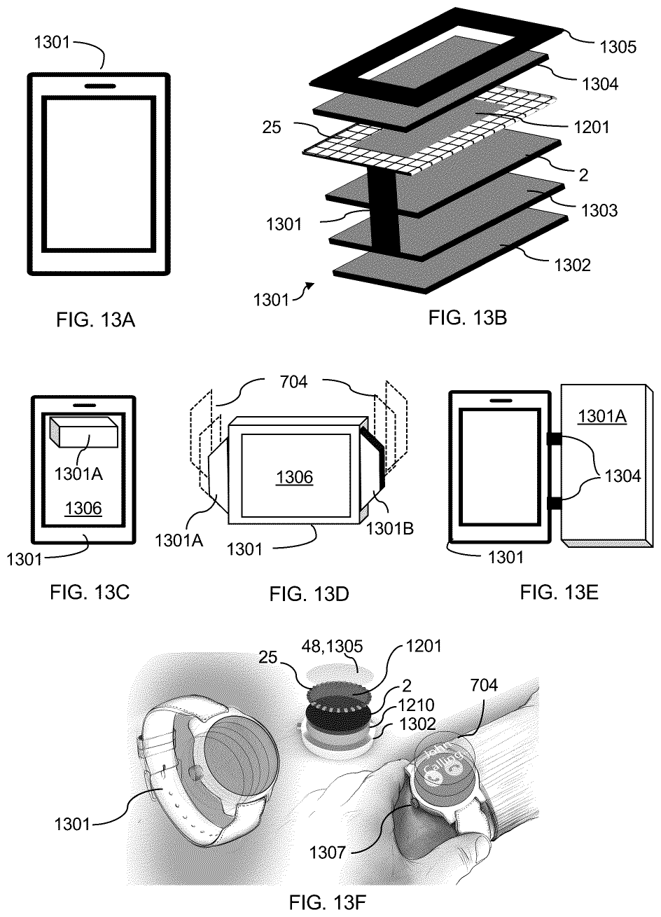

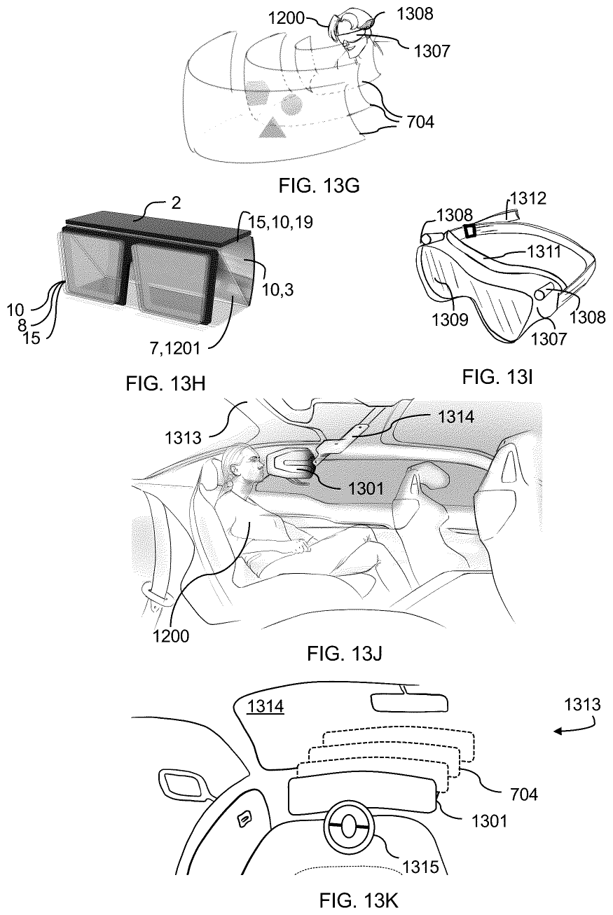

FIGS. 13A through 13P show various systems into which the display system can be integrated into portable and in-vehicle devices. Generally, the display systems here may be integrated into stereoscopic systems like ARVR headsets, vehicle instrument clusters or infotainment systems displays, smart watches, phones, tablets, laptops, computers, and electronic photoframes. The techniques introduced above here can be implemented in portable applications, including headsets, displays in automated cars, and handheld devices.

FIG. 13A shows a handheld or portable device 1301. A meshless optic may be integrated within the body as shown in FIG. 13B, which is an exploded view of the portable device 1301. The device has a back cover 1302 and a front cover 1305. The glass cover 1304, which may contain various aperture optics, is a part of the front cover in some embodiments. An electronics board 1303 powers the system and carries and electric signals to the display 2 and to the meshless optic 1201, which in this embodiment has a sensor array 25 to program a pattern in the meshless optic. In some embodiments, the architecture of FIGS. 12A through 12M are used instead to provide multifocal or virtual image effects.

A display with a meshless optic may be included as an add-on feature to an existing portable device. For example, as shown in FIG. 13C, a portable device 1301 has fixed onto the top of the viewable screen 1306 a secondary display system 1301A which incorporates a meshless optic within it. In this embodiment, the imaging-forming light source for the secondary display system is the light from the primary viewable screen 1306. In contrast, in FIG. 13D, the portable device 1301 has a viewable screen 1306 has a first and second secondary display system 1301A, 1301B which are mechanically coupled to the sides of the device. The secondary display systems have meshless optics, which produce virtual images. And in FIG. 13E, the secondary display system 1301A is attached to the portable device 1301 via mechanical couplers 1304, such as hinges or joints.

In another embodiment, as shown in FIG. 13F, the portable device 1301 is a smart watch. In its function a user may view a virtual image 704 and control or impact the content through an input button 1307. In an exploded view, the watch has a back cover 1302 and a front cover 1305, a display 2, and a meshless optic 1201 that is patterned by a sensor array 25. In some embodiments, the content control through the button impacts the signaling of that sensor array. In some embodiments, there is a coaxial FEC to provide virtual images at varying monocular depths. In some embodiments, there is a buffer PMMA or transparent elastic polymer layer between the elements of the FEC, including the meshless optic. In some embodiments, there is an air or dielectric gap between the meshless optic 1201 and the other components. The gap may range from 10 um to 100 um, 100 um to 1 mm, 1 mm to 5 mm, or 100 um to 3 mm.

Portable devices also include headsets for augmented-, virtual, and mixed-reality environments.

In FIG. 13G, a viewer 1200 wears a headset 1307, which in some embodiments includes a sensor 1308 such as an eye tracking sensor to monitor the viewer's eye or head position and adjust content accordingly. The viewer sees virtual images 704, which is multifocal in some embodiments. In some embodiments, the virtual images rely on binocular depth perception by sending different images to each eye and using parallax cues. In some embodiments, the sensor includes other sensors such as gyroscopes, accelerators, or gesture sensors to infer user motion and position. In some embodiments, the sensor includes a headset that communicates wirelessly with other individuals.

In the headset device in FIG. 13H, the display 2 emits light rays that are reflected by the cavity's beams splitter surface and meshless optic 7, 1201 and then by a single mirror 3, which may rotate the polarization with a QWP 10 to allow transmission to the viewer. The mirror may be curved. The radius of curvature may be one value horizontally (include a value of infinity, corresponding to a flat horizontal curvature) and a different value virtually. The light travels through the post-cavity optics and shield layer 10, 8, 15 to the user to provide an extended head zone. Here, unlike in other headsets, the field of view (eyebox) of the left eye overlaps with that of the right eye, and the views are separated from each eye via polarization. This allows much better picture accuracy and reduces the nose blockage area present for headsets with two separate eye channels that come from separate displays. In an alternate embodiment, the display emits light, which is reflected by the beam splitter surface

In this embodiment, different polarizations of light can reach different eyes, so as to provide both monocular depth cues as well as stereopsis, with no need for adjustment for the interpupillary distance of the user. The polarization is switched by an LC layer on top of the higher-frame-rate display such that frames are sent to the left eye and right eye alternatively. In both figures, the emissive display might be arbitrarily engineered. It might be curved, autostereoscopic, macroformed, or have an FEC or an OFEC on it or around it.

All the embodiments illustrated above can also provide left-eye/right-eye images in a headset format by using an alternating polarization and by gating the polarization per eye with polarization elements. In some embodiments, the polarization may not be alternating in time at all but might be provided by two displays that are inserting the light in perpendicular polarizations onto a beam splitter that is then placed as the input emissive display in the enclosure. This allows all the layers to be passive, so there is no need for temporal switching if desired. In some embodiments, more than two gates are controlled by a head-tracking or eye-tracking camera to shift the x- and y-polarizations across the viewable zone. Here the left eye and the right eye see slightly different images, and the user experiences parallax and therefore stereopsis. The size of these vertical segments may vary depending on the desired headbox. These vertical segments are EO-shutters 32, 33 in FIG. 2A. Here, the shutters switch in sync with the left eye/right-eye frames shown by the display, and this may be done dependent on the interpupillary distance of the eyes of the user. With this mechanism, all the embodiments above can also provide left-eye/right-eye images to provide stereopsis with multiple monocular depths.

Headsets can be used for both occlusive VR applications, as well as transparent, or see-through, augmented reality (AR) applications. For example, in FIG. 13I, the headset 1307 provides both monocular and stereoscopic depth, and it has a continuous aperture 1309 without separation for each eye. The continuous aperture increases binocular overlap and eliminates nose blockage. Further, it does not require interpupillary adjustments. The headset 1307 can have a strap 1312, such as an elastic strap, to be worn around the viewer's head, and comfort-fitting protection 1311 can be added to reduce fatigue. In some embodiments, the sensors are outward facing cameras for spatial localization and mapping features.

FIG. 13J shows an example embodiment as used in an automobile, or any other type of vehicle, for entertainment. In the interior of the vehicle 1313 the display system can be folded up into the celling of the vehicle or cabin. A mechanical support 1314 for the display system can be a folding arm that extends telescopically or can move up and down such that the display system 1301 is moved to a comfortable region for the viewer 1200, who is the passenger in this example.

FIG. 13K shows the implication of techniques introduced here for in-car dashboard applications. Here, the display system 1301 is an instrument cluster or digital interface layer. Virtual image layers 704 that are sunken into the display system, away from the driver or operator of the vehicle. These images appear to the driver to be located at deeper depth layers, beyond the physical location of the display. In some embodiments, the disclosed methods can be used to bring two or multiple layers of depth into a tablet interface inside the vehicle such that the interaction buttons appear to be popping out of, or sunken into, the touch screen. In some embodiments, the car's odometer may appear closer than the map, or there might be a multi-layer interface shown in the instrument cluster. In some embodiments, the depths of layers might be significantly different such that the close layers are a few centimeters away from the user, but the deeper layers are optically a few meters away. This disparity reduces the driver's eye fatigue or eye adjustments while alternating looking at the road and then at the instrument cluster.

It is also possible to integrate the embodiments of this invention with other optical elements, such as parallax barriers, polarization shutters, or lenticular arrays to send different images to different eyes. In some embodiments, this is aided with an eye tracking module, and in some embodiments, the other optical elements are worn as a headset. These systems then may produce both monocular depth cues and stereoscopic depth cues to trigger accommodation and vergence binocular vision.

Although the invention has been explained in relation to its preferred embodiments, it is to be understood that many other modifications and variations can be made without departing from the spirit and scope of the invention as hereinafter claimed.

In this document, the terms “machine readable medium,” “computer readable medium,” and similar terms are used to refer to non-transitory mediums, volatile or non-volatile, that store data and/or instructions that cause a machine to operate in a specific fashion. Common forms of machine-readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The various embodiments set forth herein are described in terms of exemplary block diagrams, flow charts and other illustrations. As will become apparent to one of ordinary skills in the art after reading this document, the illustrated embodiments and their various alternatives can be implemented without confinement to the illustrated examples. For example, block diagrams and their accompanying description should not be constructed as mandating a particular architecture or configuration.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in several ways. Different combinations and sub-combinations are intended to fall within the scope of this disclosure, and certain method or process blocks may be omitted in some implementations. Additionally, unless the context dictates otherwise, the methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine, but deployed across a number of computational resources.

As used herein, the term “or” may be constructed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be constructed as open ended as opposed to limiting. Adjectives such as “conventional,” “traditional,” “normal,” “standard,” “known,” and terms of similar meaning should not be constructed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed:

1. An optical system, comprising:
a light source emitting light forming an image;
a secondary source to generate a pattern;
a programming element to be modified by the pattern; and
a modulation element disposed along a path of the light and coupled to the programming element to (i) receive the light and (ii) modify a transversely varying optical property of the light in accordance with the pattern, the transversely varying optical property free from farfield diffractive artifacts.

2. The optical system of claim 1, wherein the image spans a lateral distance of at least 10 cm.

3. The optical system of claim 1, further comprising an FEC having at least two specular reflectors disposed along the path of the light, wherein the image is a virtual image with at least one monocular depth and is viewable in a headbox having a lateral size of at least 10 cm.

4. The optical system of claim 3, wherein the modulation element is disposed on a surface of a specular reflector among the plurality of specular reflectors.

5. The optical system of claim 1, wherein:
the secondary source is an optical source;
the programming element is a photoresponsive element; and
the modulation element is an electro-optic element,
and further comprising a filter and a polarizer, the filter and the polarizer disposed along the path of the light.

6. The optical system of claim 5, wherein the photoresponsive material comprises a transparent photovoltaic material or a transparent conductor.

7. The optical system of claim 1, wherein:
the secondary source comprises an ultraviolet (UV) optical source and an addressable matrix;
the modulation element comprises a luminescent element,
and further comprising a color filter to remove stray light.

8. The optical system of claim 1, wherein the light source emits white light.

9. The optical system of claim 1, further comprising a cavity, the modulation element disposed within the cavity.

10. The optical system of claim 1, wherein the modulation element is pixelated.

11. The optical system of claim 1, wherein the modulation element comprises a photorefractive material, and the transversely varying optical property is an optical phase.

12. The optical system of claim 1, wherein the image is a multifocal virtual image comprising a first focal plane and a second focal plane, the pattern based on a first display content of the first focal plane and the transversely varying optical property impacting a second display content on the second focal plane.

13. The optical system of claim 1, wherein the programming element is pixelated.

14. An optical system, comprising
a light source emitting light forming an image;
a secondary source to generate a pattern; and
a meshless optic disposed along a path of the light and coupled to the secondary source and having
a modulation material to receive the pattern, and
a programming material, wherein
the meshless optic (i) receives the light, and (ii) modifies a transversely varying optical property of the light in accordance with the pattern, the transversely varying optical property free from farfield diffractive artifacts.

15. The optical system of claim 14, wherein the meshless optic comprises a phase change material, and the secondary source is thermally coupled to the phase change material.

16. The optical system of claim 14, wherein the meshless optic comprises a multilayer stack.

17. The optical system of claim 16, wherein a layer of the multilayer stack is a polymer, the secondary source changing a local thickness of the polymer.

18. The optical system of claim 14, wherein the secondary source is the light from the light source, and the meshless optic is a nonlinear material.

19. The optical system of claim 14, wherein the modulation material is an electro-optic substrate, and the programming material is dispersed or doped in the electro-optic substrate.

20. The optical system of claim 19, wherein the programming material is a dispersal of resonant nanoparticles.

21. The optical system of claim 14, wherein the meshless optic comprises a dispersal of luminescent particles.

22. The optical system of claim 21, wherein the meshless optic further comprises a dispersal of resonant nanoparticles coupled to the luminescent particles.

23. An optical system, comprising:
a light source emitting light forming an image;
a secondary source to generate a pattern;
a programming element to be modified by the pattern; and
a modulation element disposed along a path of the light and coupled to the programming element to (i) receive the light and (ii) modify a transversely varying optical property of the light in accordance with the pattern,
the transversely varying optical property free from farfield diffractive artifacts, wherein the secondary source is a source array disposed on the programming element.

24. The optical system of claim 23, wherein the source array is an array of electrodes.

25. The optical system of claim 24, wherein the image is a multifocal virtual image comprising a first focal plane and a second focal plane, the pattern based on a first display content of the first focal plane and the transversely varying optical property impacting a second display content on the second focal plane.

26. The optical system of claim 24, wherein the programming element is a photoresponsive element.

27. The optical system of claim 24, wherein the modulation element is a nonlinear material.

28. The optical system of claim 23, wherein the source array is an array of acoustic or mechanical transducers.

29. The optical system of claim 28, wherein the modulation element is an elastic membrane having a dispersal of luminescent particles.

30. The optical system of claim 23, wherein the source array is an array of thermo-electric transducers, and further comprising a conducting slab disposed between the programming element and the modulation element.
